(19) United States
(12) Patent Application Publication
(10) Pub. No.: US 2014/0278885 A1
(43) Pub. Date: Sep. 18, 2014

(54) ELECTRONIC OFFER MANAGEMENT SYSTEM AND METHOD THEREFOR

(71) Applicants: Penny H. Baron, Reno, NV (US); Wayne H. Levy, Deerfield, IL (US); Brian M. Rock, Kildeer, IL (US); Timothy E. Halfman, Schaumburg, IL (US); Mark S. Smith, West Hartford, CT (US)

(72) Inventors: Penny H. Baron, Reno, NV (US); Wayne H. Levy, Deerfield, IL (US); Brian M. Rock, Kildeer, IL (US); Timothy E. Halfman, Schaumburg, IL (US); Mark S. Smith, West Hartford, CT (US)

(73) Assignee: COUPONS.COM INCORPORATED, Mountain View, CA (US)

(21) Appl. No.: 13/831,735

(22) Filed: Mar. 15, 2013

(51) Int. Cl. G06Q 30/02

(52) U.S. Cl. CPC G06Q 30/0238
USPC 705/14.27; 705/14.38

(57) ABSTRACT

An electronic offer management system and method thereof is disclosed. In particular, the system comprises means for receiving information related to a plurality of offers distributed by a plurality of different offer distributors to customer for redemption at plurality of stores, means for automatically routing the information related to an offer to a point-of-sale system of each store in which the offer can be redeemed, and means for automatically clearing the offers redeemed by the customer at the stores. The system further comprises means for automatically reconciling financial obligations associated with each cleared offer, as well means for dynamically profiling customers so that improved offer targeting can be achieved.

### CROSS-REFERENCE TO RELATED APPLICATIONS; BENEFIT CLAIM

This application is a continuation of application Ser. No. 13/588,777, filed Aug. 17, 2012; which is a continuation of application Ser. No. 13/082,182, filed Apr. 7, 2011; which is a continuation of application Ser. No. 12/273,953, filed Nov. 19, 2008; which is a continuation of application Ser. No. 11/438,969, filed May 23, 2006, which is a continuation of application Ser. No. 09/665,790, filed Sep. 20, 2000. The contents of each of these applications are hereby incorporated by reference for all purposes as if set forth in their entirety herein. The applicants hereby rescind any disclaimer of claim scope in the parent applications or the prosecution history thereof and advise the USPTO that the claims in this application may be broader than any claim in the parent application.

### BACKGROUND OF THE INVENTION

The present invention relates generally to an electronic offer management system and method thereof, and more particularly to a system that enables the electronic management of offers distributed by a plurality of different offer distributors to customers and the dynamic profiling of such customers so that improved offer targeting can be achieved.

Today, about twenty percent (20%) of all sales in grocery retail are covered by some promotion or offer. These offers are found in a variety of forms including temporary price reductions, in-store displays, manufacturer-sponsored coupon offers, advertisements, and frequent shopper (i.e., loyalty) discounts. Traditionally, such offers have been distributed to customers via “physical” media (i.e. direct mailers, printers, displays at the register, Sunday coupon inserts, magazines, etc.). Given the manual nature of such a system of distribution, however, customer-specific offers based on a variety of factors, such as demographics, past purchasing behavior, and price sensitivity are impractical. This in turn has a substantial impact on the effectiveness and cost of providing offers through such a system. For retailers having numerous competing product lines, such as supermarkets, this offer targeting capability is critical. Moreover, clearing and settlement of offers distributed in such a manner is technically infeasible with respect to time, labor and thus, cost intensive.

With the advent of the Internet as a new ecommerce tool, offers are now also being distributed “virtually” to customers. For example, companies such as Cool Savings, PlanetU and ValuPage are operating websites from which customers can obtain coupons redeemable at various retail stores and supermarkets, as well as at stores having an online presence. Traditional retailers are also beginning to distribute offers online. For example, Schnucks supermarket provides its weekly advertisements, as well as coupons online. Offer targeting across a plurality of different offer distributors or based on “non-customer” data, such as price, is not allowed. Moreover, the clearance and settlement of such offers are still performed largely through a manual process and in a decentralized manner. As a result, fraudulently fabricated offers cannot be accurately tracked and thus, prevented.

Finally, under current methods of offer distribution, retailers must customize their point-of-sale (POS) system according to each offer distributor's technical design structure. In addition, the entire offer transaction from creation through redemption, clearance and settlement is not centralized, thereby increasing the complexity of the interfaces needed between the parties to the entire transaction. Moreover, data relevant to the transaction and necessary for sophisticated levels of targeting cannot be obtained from a single source, thereby decreasing its accessibility, accuracy and completeness. Given that the primary purpose of providing such offers is to drive up the number of new sales, the inability to manage electronic offers in a centralized manner and to dynamically profile customers and target offers increases the overall costs and effectiveness of the offers.

Accordingly, there is a need for an electronic offer management system in which offers can be distributed by a plurality of different offer distributors for automatic routing to a store's point of sale system, and in which such offers can be automatically cleared and settled once redeemed, such that an electronic audit of the entire offer transaction, and dynamic profiling of customers for improved offer targeting can be achieved.

### SUMMARY OF THE INVENTION

An electronic offer management system for offer transactions is disclosed. The system comprises receiving means for receiving information related to a plurality of offers distributed by a plurality of different offer distributors to customers for redemption at a plurality of stores, routing means for automatically routing the information related to each offer to a point-of-sale system of each store in which the offer can be redeemed, and clearing means for automatically clearing the offers redeemed by the customers at the stores. The plurality of offer distributors comprises at least one of an interne offer distributor, a retailer offer distributor, a kiosk offer distributor, a direct mail offer distributor, and an email offer distributor.

The clearing means comprises means for receiving redemption information from the stores, and means for comparing the redemption information to the offer information whereby each offer redeemed by the customers can be validated. The system further comprises settlement means for automatically reconciling financial obligations associated with each offer cleared by the clearing means, whereby a single, electronic audit of each offer transaction can be achieved.

The system further comprises activation means for selectively activating and deactivating each offer. The system also further comprises profiling means for dynamically profiling the customers so that the offers can be targeted to specific customers, and offer consolidation means for consolidating the offers available through the system for presentation to the customer at a plurality of levels. The profiling means preferably comprises at least one of a static profile, a persistent profile and a dynamic profile. The plurality of levels comprises at least one of an offer distributor level and a store level. Each offer corresponds to a reward, and the system further comprises reward deferral means for deferring issuance of the reward to a third party. The offer information comprises at least one condition, which is at least one of an item purchase condition, a department purchase condition, a total purchase condition, a time of day condition and a day of the week condition.

A method of electronic management of offer transactions is also disclosed. The method comprises receiving information related to a plurality of offers distributed by a plurality of different offer distributors to customers for redemption at a plurality of stores, automatically routing the information of each offer to a point-of-sale system of each store in which the offer can be redeemed, and automatically clearing the offers redeemed by the customers at the stores.

The method further comprises the step of automatically reconciling financial obligations associated with each cleared offer whereby a single, electronic audit of each offer transaction can be achieved. The method also further comprises the step of receiving redemption information from the stores, and comparing the redemption information to the offer information whereby each offer redeemed by the customers can be validated. The method also preferably comprises the step of selectively activating each offer, and consolidating the offers for presentation to the customer at a plurality of levels, such as offer distributor level and a store level. The method also further comprises the step of dynamically profiling the customers so that the offers can be targeted to specific customers.

### BRIEF DESCRIPTION OF THE DRAWINGS

FIG. 1 illustrates the flow of information in an electronic offer management system in accordance with the present invention.

FIG. 2 is a flowchart representing the process of dynamic profiling provided by the system of FIG. 1

FIG. 3A is a spreadsheet showing an example of a non-targeted offer.

FIG. 3B is a spreadsheet showing an example of a static profile-targeted offer generated through the system of FIG. 1.

FIG. 3C is a spreadsheet showing an example of a persistent profile-targeted offer generated through the system of FIG. 1.

FIG. 3D is a spreadsheet showing an example of a dynamic profile-targeted offer generated through the system of FIG. 1.

### DETAILED DESCRIPTION OF THE PREFERRED EMBODIMENTS

The present invention is directed to an electronic offer management system and method thereof. FIG. 1 illustrates the main components of the system represented as 10, as well as the flow of information there through. In summary, offers are distributed to customers by a plurality of different offer distributors 12. The details of the offers are communicated to an electronic clearing network 13 and routed to the appropriate store 28 for redemption by customers. Transaction log files containing point-of-sale transaction details are forwarded back to network 13 where a clearing process identifies what offers have been redeemed and validates them against the offers communicated to network 13.

Settlement details are also prepared for processing by a settlement agent 30. For the purposes of discussion only, system 10 will be described with respect to offers written in extensive Markup language (XML) having a representative documentation convention for XML element and attribute tags as described below. It can be appreciated by one skilled in the art, however, that the offer may be defined using other languages or formats that allow for the functionality described herein, such as for example the Hypertext Markup language.

| Element/Attribute Tag | Description |
|---|---|
| /SOX | Element aggregate tag. |
| /SOX/@Version | Element attribute tag identified with a @. |
| /SOX/Offer/OfferMaintReq/ | Shortened form for: |
| OfferProperties | /SOX/Offer/OfferMaintReq/OfferProperties/MemberOffer |
| . . . /MemberOffer | |
| . . . /RewardSet[ ]/ItemPurchase/ | Element list has [ ] appended (occurrence indicator). In |
| ItemList/Item[ ] | the example . . . /RewardSet[ ] is an aggregate element that |
| | must appear once or many times. |
| | In this example, the . . . /Item[ ] element must appear once or |
| | many times within each instance of /RewardSet[ ]. |

Referring to FIG. 1, the process starts through the distribution of an offer to a customer by an offer distributor 12 that is available for redemption at one or more stores 28, which can be traditional brick-and-mortar stores, direct mail stores, online stores or any other type or form of store. In one embodiment, this is done in conjunction with a manufacturer (not shown) who is the sponsor of the offer and thus, bears the cost of it. Offers are distributed via a plurality of different offer distributors including but not limited to Internet offer distributors 14, in-store kiosk offer distributors 16, retailer offer distributors 18, and direct mail/email offer distributors 20. System 10 operates using five (5) XML document types, namely Offer, CustomerOffer, OfferAck, CustomerOfferAck and ErrorResponse.

The Offer document type defines the generic offer setup (i.e. offer properties, conditions, and rewards) and routing instructions. In a preferred embodiment, each Offer document is limited to information related to a single offer being distributed by a particular offer distributor 12. The maintenance actions supported by the Offer document type are to add, replace or delete an offer, and are identified in a tabular format as shown below.

| XML Element/Attribute | | Max | | | |
|---|---|---|---|---|---|
| Tag | Data Type | Len | Occur | Usage | Description |
| /SOX/Offer | Aggregate | 0 | Once | Required | Offer: |
| | | | | Always | The /SOX/Offer aggregate element |
| | | | | | may contain: |
| | | | | | One /SOX/Offer/OfferMaintReq |
| | | | | | aggregate element and one |
| | | | | | /SOX/Offer/OfferRouteReq aggregate |
| | | | | | element; |
| | | | | | OR |
| | | | | | One /SOX/Offer/OfferMaintReq |
| | | | | | aggregate element only; |
| | | | | | OR |
| | | | | | One /SOX/Offer/OfferRouteReq |
| | | | | | aggregate element only. |
| . . . /@OfferID | String | 12 | Once | Required | Offer ID: |
| | | | | Always | Number is provided by offer |
| | | | | | distributor and must be unique for |
| | | | | | that distributor. |
| . . . /OfferMaintReq | Aggregate | 0 | Once | Optional | Offer Maintenance Request: |
| | | | | | Encapsulates Offer maintenance |
| | | | | | request details for @OfferID |
| | | | | | above. |
| . . . /OfferMaintReq/@Action | Enumerated | 7 | Once | Required | Action: |
| | String | | | | Offer maintenance action |
| | | | | | requested. |
| | | | | | Valid values: |
| | | | | | Add |
| | | | | | Replace |
| | | | | | Delete |

The CustomerOffer document type defines any customer-specific offer setup and routing instructions. The OfferAck document type represents the positive acknowledgement returned by the network 13 upon its successful processing of an Offer document type. Likewise, CustomerOfferAck document type represents the positive acknowledgement returned by the network 13 upon its successful processing of a CustomerOffer document type. Finally, ErrorResponse document type represents the negative acknowledgement returned by the network 13 upon encountering an error in the course of processing an Offer or CustomerOffer document type. These document types preferably adhere to the document type definition (DTD) as identified in Appendix 1.

There are three (3) main components to each offer, namely offer properties, conditions, and rewards. Offer properties are the data elements that serve to generally describe an offer, such as a description, valid date range, and the number of times a customer may receive the reward(s) associated with that offer. Each Offer document includes a header, a representative sample of which is identified in a tabular format below.

| XML Element/Attribute | | Max | | | |
|---|---|---|---|---|---|
| Tag | Data Type | Len | Occur | Usage | Description |
| /SOX | Aggregate | 0 | Once | Required | Document Root Element: |
| | | | | Always | Identifies this as a SOX XML |
| | | | | | document. |
| . . . /@OfferDistributorID | String | 6 | Once | Required | Offer Distributor ID: |
| | | | | Always | Assigned by the ECN. |
| | | | | | Value = 1-999999 |
| . . . /@SenderDocUID | String | 12 | Once | Required | Sender's Document Unique ID: |
| | | | | Always | Sender's unique reference code |
| | | | | | for this document for audit |
| | | | | | trail purposes. |
| . . . /@Version | String | 3 | Once | Required | SOX Version of File: |
| | | | | Always | Version of SOX to which this |
| | | | | | document conforms. |
| | | | | | Value = 1.0 |
| . . . /@AckRequested | Enumerated | 7 | Once | Required | Acknowledgement Requested: |
| | String | | | Always | Defines type of |
| | | | | | acknowledgement requested. |
| | | | | | Supported values: |
| | | | | | Normal |
| | | | | | Terse |
| | | | | | Verbose |
| . . . /@SOXType | Enumerated | 5 | Once | Required | Sox Type: |
| | String | | | Always | Indicates type of SOX XML |
| | | | | | document. All SOX documents |
| | | | | | have this attribute with |
| | | | | | appropriate values. |
| | | | | | Value = Offer |

The header includes an @Offer DistributorID parameter that represents an identifier assigned by the network 13 for each offer distributor 12 of system 10. The @SenderDocUID parameter represents a unique reference code which identifies the XML document to its sender so he or she can later refer to it. This parameter is used for audit trail purposes. The @Version parameter represents the version of the specification to which the Offer document conforms. The @AckRequested parameter defines the type of acknowledgement requested for the Offer document (i.e., normal, terse, verbose). The @SOXType document identifies the type of XML document (in this case, “Offer”).

A representative sample of the plurality of offer properties available through system 10 is identified in a tabular format as shown below.

| XML Element/Attribute | | Max | | | |
|---|---|---|---|---|---|
| Tag | Data Type | Len | Occur | Usage | Description |
| /SOX/Offer/OfferMaintReq/ | Aggregate | 0 | Once | Optional | Offer Properties: |
| OfferProperties | | | | | Contains Offer Properties for |
| | | | | | @OfferID above. |
| | | | | | This element is required when |
| | | | | | /SOX/Offer/@Action = “Add” or |
| | | | | | “Replace”. |
| | | | | | It is not required when |
| | | | | | /SOX/Offer/@Action = “Delete”. |
| . . . /MemberOffer | String | 3 | Once | Required | Member Offer: |
| | | | | | Is loyalty program membership |
| | | | | | required? |
| | | | | | Valid values: |
| | | | | | Yes |
| | | | | | No |
| | | | | | When membership is not a |
| | | | | | requirement, all customers are |
| | | | | | eligible to participate in the |
| | | | | | Offer. |
| . . . /StaffAllowed | String | 3 | Once | Required | Staff Allowed: |
| | | | | | Can staff participate in this |
| | | | | | offer? |
| | | | | | Valid values: |
| | | | | | Yes |
| | | | | | No |
| . . . /OfferType | String | 6 | Once | Required | Offer Type: |
| | | | | | Coupon type for monetary |
| | | | | | rewards. (For tax calculations.) |
| | | | | | Valid values: |
| | | | | | Vendor |
| | | | | | Store |
| . . . /OfferXactLimit | String | 2 | Once | Required | Offer Transaction Limit: |
| | | | | | Maximum number of times this |
| | | | | | offer may be used per |
| | | | | | transaction. |
| | | | | | Value = 0-9, or -1 |
| | | | | | (=unlimited). |
| | | | | | If value = 0, this offer is not |
| | | | | | active. |
| . . . /OfferCustLimit | String | 2 | Once | Required | Offer Customer Limit: |
| | | | | | Total number of times this offer |
| | | | | | may be used, across |
| | | | | | transactions. |
| | | | | | Value = 0-9, or -1 |
| | | | | | (=unlimited). |
| . . . /OfferStartDateTime | Aggregate | 0 | Once | Required | Offer Start Date Time: |
| | | | | | Date/time when the offer becomes |
| | | | | | active. |
| | | | | | Encapsulates the elements that |
| | | | | | define the timestamp. |
| . . . /OfferStartDateTime/ | String | 4 | Once | Required | Offer Start Date Time: Year |
| Year | | | | | Format: CCYY |
| . . . /OfferStartDateTime/ | String | 2 | Once | Required | Offer Start Date Time: Month |
| Month | | | | | Format: MM |
| | | | | | Value = 01-12 |
| . . . /OfferStartDateTime/ | String | 2 | Once | Required | Offer Start Date Time: Day |
| Day | | | | | Format: DD |
| | | | | | Value = 01-31 |
| . . . /OfferStartDateTime/ | String | 2 | Once | Required | Offer Start Date Time: Hour |
| Hour | | | | | Format: HH |
| | | | | | Value = 00-23 |
| . . . /OfferStartDateTime/ | String | 2 | Once | Required | Offer Start Date Time: Minute |
| Minute | | | | | Format: MM |
| | | | | | Value = 00-59 |
| . . . /OfferEndDateTime | Aggregate | 0 | Once | Required | Offer End Date Time: |
| | | | | | Date/time after which the offer |
| | | | | | expires. |
| | | | | | Encapsulates the elements that |
| | | | | | define the timestamp. |
| . . . /OfferEndDateTime/ | String | 4 | Once | Required | Offer End Date Time: Year |
| Year | | | | | Format: CCYY |
| . . . /OfferEndDateTime/ | String | 2 | Once | Required | Offer End Date Time: Month |
| Month | | | | | Format: MM |
| | | | | | Value = 01-12 |
| . . . /OfferEndDateTime/ | String | 2 | Once | Required | Offer End Date Time: Day |
| Day | | | | | Format: DD |
| | | | | | Value = 01-31 |
| . . . /OfferEndDateTime/ | String | 2 | Once | Required | Offer End Date Time: Hour |
| Hour | | | | | Format: HH |
| | | | | | Value = 00-23 |
| . . . /OfferEndDateTime/ | String | 2 | Once | Required | Offer End Date Time: Minute |
| Minute | | | | | Format: MM |
| | | | | | Value = 00-59 |
| . . . /OfferDescription | String | 40 | Once | Required | Offer Description: |
| | | | | | Text description of the |
| | | | | | promotion - printed on checkout |
| | | | | | receipt. |
| | | | | | Format on checkout receipt: 2 |
| | | | | | lines of 20 characters each. |
| . . . /OfferReportDescription | String | 40 | Once | Required | Offer Report Description: |
| | | | | | Text description of the offer |
| | | | | | for reporting purposes. |
| . . . /OfferSponsorSettlementID | String | 9 | Once | Required | Offer Sponsor Settlement ID: |
| | | | | | Assigned by the ECN. |
| | | | | | Value = 1-999999999 |
| . . . /DeferredReward | String | 3 | Once | Required | Deferred Reward: |
| | | | | | Is reward to be received in a |
| | | | | | deferred manner (or directed to |
| | | | | | another party), or is it to be |
| | | | | | received at checkout. |
| | | | | | Valid values: |
| | | | | | “Yes” = Deferred receipt. |
| | | | | | “No” = Checkout receipt. |

MemberOffer is a field representing whether an offer is open to the public or requires membership to a frequent shopper, loyalty or similar-type program. StaffAllowed is a field representing the employees of the store to which the offer has been routed. OfferType is a field representing whether the offer is being offered by a vendor or a store. OfferXactLimit is a field representing the maximum number of times the offer may be used by a customer per transaction. OfferCustLimit is a field representing the maximum number of times the offer may be used by a customer across transactions. OfferStartDateTime is an aggregate field representing the date and time when the offer becomes active (broken down by year, month, day, hour and minute), while OfferEndDateTime is an aggregate field representing the date and time after which the offer may not be used (broken down by year, month, day, hour and minute). OfferDescription is a field representing a text description of the offer, which is preferably printed out on the customer's checkout receipt upon redemption. OfferReportDescription is a field representing a text description of the offer for reporting purposes, such as offer performance analysis. OfferSponsorSettlementID is a field representing the unique number used to identify the sponsor of each offer. DeferredReward is a field indicating whether a reward associated with an offer is to be received in a deferred manner or directed to another party. One skilled in the art can appreciate that the number and type of offer properties may vary depending on the application.

A representative sample of the plurality of conditions required for redeeming an offer through system 10 is identified in tabular format as shown below.

| XML Element/Attribute | | Max | | | |
|---|---|---|---|---|---|
| Tag | Data Type | Len | Occur | Usage | Description |
| /SOX/Offer/OfferMaintReq/ | Aggregate | 0 | Once | Optional | Offer Conditions: |
| OfferConditions | | | | | Encapsulates the Conditions |
| | | | | | applicable to @OfferID. This |
| | | | | | element is required when |
| | | | | | . . . /Offer/@Action = “Add” or |
| | | | | | “Replace”. |
| | | | | | It is not required when |
| | | | | | . . . /Offer/@Action = “Delete”. |
| /@ConditionSetCount | String | 1 | Once | Required | Condition Set Count: |
| | | | | | Number of Condition Set |
| | | | | | instances in this document. |
| | | | | | Value = 1-7 |
| . . . /ConditionSet[ ] | Aggregate | 0 | One | Required | Condition Set: |
| | List | | or | | Encapsulates the details of a |
| | | | Many | | single Condition Set. This |
| | | | | | element must contain only one of |
| | | | | | the following available |
| | | | | | Condition Set type elements: |
| | | | | | ItemPurchase |
| | | | | | DeptPurchase |
| | | | | | TotalPurchase |
| | | | | | TimeOfDay |
| | | | | | DayOfWeek |
| . . . /ConditionSet[ ]/ | Enumerated | 1 | Once | Required | Condition Set ID: |
| @ConditionSetID | String | | | | Value = 0-7 |
| | | | | | Value must be mutually exclusive |
| | | | | | with other @ConditionSetID |
| | | | | | values and |
| | | | | | /SOX/Offer/OfferMaintReq/OfferRewards/ |
| | | | | | RewardSet[ ]/@RewardSetID values. |
| . . . /ConditionSet[ ]/ | Aggregate | 0 | Once | Optional | Item Purchase: |
| ItemPurchase | | | | | Element which encapsulates the |
| | | | | | details of the ItemPurchase |
| | | | | | Condition Set type. |
| . . . /ConditionSet[ ]/ | Enumerated | 8 | Once | Required | Measure: |
| ItemPurchase/@Measure | String | | | | Defines the basis on which this |
| | | | | | Condition Set type is measured. |
| | | | | | Valid values: |
| | | | | | Quantity |
| | | | | | Weight |
| | | | | | Amount |
| | | | | | Where “Amount” is a monetary |
| | | | | | amount. |
| | | | | | If “Weight” is specified, the |
| | | | | | Offer Distributor is responsible |
| | | | | | for ensuring that Items in |
| | | | | | ItemList are sold by weight. |
| . . . /ConditionSet[ ]/ | Aggregate | 0 | Once | Required | Item List: |
| ItemPurchase/ItemList | | | | | Encapsulates items that may be |
| | | | | | purchased interchangeably to |
| | | | | | meet this Condition. |
| . . . /ConditionSet[ ]/ | String | 4 | Once | Required | Item Count: |
| ItemPurchase/ItemList/ | | | | | The number of . . . ItemList/Item[ ] |
| @ItemCount | | | | | entries to follow. |
| | | | | | Value = 1-9999 |
| . . . /ConditionSet[ ]/ | String | 12 | One | Required | Item: |
| ItemPurchase/ItemList/ | List | | or | | UPC/EAN Code of eligible item |
| Item[ ] | | | Many | | without the check digit. All 12 |
| | | | | | digits must be specified even if |
| | | | | | leading zero's are needed. |
| | | | | | Compressed UPC is not permitted. |
| . . . /ConditionSet[ ]/ | String | 1 | Once | Required | Condition Check Flag: |
| ItemPurchase/CondChkFlg | | | | | Valid values: |
| | | | | | “0” = Once conditions are met, |
| | | | | | rewards issued for all |
| | | | | | qualifying items thereafter. |
| | | | | | “1” = Conditions must be met |
| | | | | | each time to receive rewards. |
| . . . /ConditionSet[ ]/ | String | 10 | Once | Required | Measure Value: |
| ItemPurchase/MeasureValue | | | | | Metric of |
| | | | | | . . . /ItemPurchase/@Measure |
| | | | | | required to be purchased. |
| | | | | | Value = 1-2147483647 |
| | | | | | If . . . /ItemPurchase/@Measure = |
| | | | | | Quantity, Value is in units. = |
| | | | | | Weight, Value is in hundredths |
| | | | | | of pounds. = |
| | | | | | Amount, Value is in cents. |
| . . . /ConditionSet[ ]/ | Aggregate | 0 | Once | Optional | Department Purchase: |
| DeptPurchase | | | | | Element which encapsulates the |
| | | | | | details of the DeptPurchase |
| | | | | | Condition Set type. |
| | | | | | The Offer Distributor is |
| | | | | | responsible for the correct |
| | | | | | identification of departments. |
| | | | | | It is recommended that only the |
| | | | | | store operator uses this |
| | | | | | Condition Set type. |
| . . . /ConditionSet[ ]/ | Aggregate | 0 | Once | Required | Department List: |
| DeptPurchase/DeptList | | | | | Element encapsulating the store |
| | | | | | departments from which items may |
| | | | | | be purchased interchangeably to |
| | | | | | meet this Condition. |
| . . . /ConditionSet[ ]/ | String | 4 | Once | Required | Department Count: |
| DeptPurchase/DeptList/ | | | | | The number of . . . DeptList/Dept[ ] |
| @DeptCount | | | | | entries to follow. |
| | | | | | Value = 1-9999 |
| . . . /ConditionSet[ ]/ | String | 4 | One | Required | Department: |
| DeptPurchase/DeptList/ | List | | or | | Store department from which |
| Dept[ ] | | | Many | | items must be purchased. |
| | | | | | Value = 1-9999 |
| . . . /ConditionSet[ ]/ | String | 1 | Once | Required | Condition Check Flag: |
| DeptPurchase/CondChkFlg | | | | | Valid values: |
| | | | | | “0” = Once conditions are met, |
| | | | | | rewards issued for all |
| | | | | | qualifying items thereafter. |
| | | | | | “1” = Conditions must be met |
| | | | | | each time to receive rewards. |
| . . . /ConditionSet[ ]/ | String | 10 | Once | Required | Amount: |
| DeptPurchase/Amount | | | | | The monetary amount required to |
| | | | | | be purchased expressed in cents. |
| | | | | | Value = 1-2147483647 |
| . . . /ConditionSet[ ]/ | Aggregate | 0 | Once | Optional | Total Purchase: |
| TotalPurchase/ | | | | | Element which encapsulates the |
| | | | | | details of the TotalPurchase |
| | | | | | Condition Set type. |
| . . . /ConditionSet[ ]/ | Enumerated | 12 | Once | Required | Includes: |
| TotalPurchase/@Includes | String | | | | Defines whether “All” items or |
| | | | | | only those that are |
| | | | | | “Discountable” are included in |
| | | | | | the total of purchases to be |
| | | | | | evaluated. |
| | | | | | Valid values: |
| | | | | | All |
| | | | | | Discountable |
| . . . /ConditionSet[ ]/ | String | 1 | Once | Required | Condition Check Flag: |
| TotalPurchase/CondChkFlag | | | | | Valid values: |
| | | | | | “0” = Once conditions are met, |
| | | | | | rewards issued for all |
| | | | | | qualifying items thereafter. |
| | | | | | “1” = Conditions must be met |
| | | | | | each time to receive rewards. |
| . . . /ConditionSet[ ]/ | String | 10 | Once | Required | Amount: |
| TotalPurchase/Amount | | | | | The total monetary amount |
| | | | | | required to be purchased |
| | | | | | expressed in cents. |
| | | | | | Value = 1-2147483647 |
| . . . /ConditionSet[ ]/ | Aggregate | 0 | Once | Optional | Time Of Day: |
| TimeOfDay | | | | | Element which encapsulates the |
| | | | | | details of the TimeOfDay |
| | | | | | Condition Set type. |
| . . . /ConditionSet[ ]/ | Aggregate | 0 | Once | Required | Start Time: |
| TimeOfDay/StartTime | | | | | Encapsulates the details of |
| | | | | | StartTime. |
| . . . /ConditionSet[ ]/ | String | 2 | Once | Required | Hour: |
| TimeOfDay/StartTime/ | | | | | Format: HH |
| Hour | | | | | Value: 00-23 |
| . . . /ConditionSet[ ]/ | String | 2 | Once | Required | Minute: |
| TimeOfDay/StartTime/ | | | | | Format: MM |
| Minute | | | | | Value: 00-59 |
| . . . /ConditionSet[ ]/ | Aggregate | 0 | Once | Required | End Time: |
| TimeOfDay/EndTime | | | | | Encapsulates the details of |
| | | | | | EndTime. |
| . . . /ConditionSet[ ]/ | String | 2 | Once | Required | Hour: |
| TimeOfDay/EndTime/ | | | | | Format: HH |
| Hour | | | | | Value: 00-23 |
| . . . /ConditionSet[ ]/ | String | 2 | Once | Required | Minute: |
| TimeOfDay/EndTime/ | | | | | Format: MM |
| Minute | | | | | Value: 00-59 |
| . . . /ConditionSet[ ]/ | Aggregate | 0 | Once | Optional | Day Of Week: |
| DayOfWeek | | | | | Element which encapsulates the |
| | | | | | details of the DayOfWeek |
| | | | | | Condition Set type. |
| . . . /ConditionSet[ ]/ | String | 3 | Once | Required | Sunday: |
| DayOfWeek/Sunday | | | | | Indicates whether the Offer is |
| | | | | | available on Sundays. Note that |
| | | | | | at least one of the days should |
| | | | | | have a “Yes” value. |
| | | | | | Valid values: |
| | | | | | Yes |
| | | | | | No |
| . . . /ConditionSet[ ]/ | String | 3 | Once | Required | Monday: |
| DayOfWeek/Monday | | | | | Valid values: |
| | | | | | Yes |
| | | | | | No |
| . . . /ConditionSet[ ]/ | String | 3 | Once | Required | Tuesday: |
| DayOfWeek/Tuesday | | | | | Valid values: |
| | | | | | Yes |
| | | | | | No |
| . . . /ConditionSet[ ]/ | String | 3 | Once | Required | Wednesday: |
| DayOfWeek/Wednesday | | | | | Valid values: |
| | | | | | Yes |
| | | | | | No |
| . . . /ConditionSet[ ]/ | String | 3 | Once | Required | Thursday: |
| DayOfWeek/Thursday | | | | | Valid values: |
| | | | | | Yes |
| | | | | | No |
| . . . /ConditionSet[ ]/ | String | 3 | Once | Required | Friday: |
| DayOfWeek/Friday | | | | | Valid values: |
| | | | | | Yes |
| | | | | | No |
| . . . /ConditionSet[ ]/ | String | 3 | Once | Required | Saturday: |
| DayOfWeek/Saturday | | | | | Valid values: |
| | | | | | Yes |
| | | | | | No |

Conditions are the rules or requirements for receiving the reward(s) associated with a particular offer. The conditions associated with an offer are defined by a plurality of condition sets. In one embodiment, there are five (5) types of condition sets, namely an item purchase condition set, a department purchase condition set, a total purchase condition set, a time of day condition set and a day of week condition set. The item purchase condition set identifies the item or items that must be purchased, which can be broken down by quantity, weight and/or amount. The department purchase condition set identifies the department or departments from which each item must be purchased. The total purchase condition set identifies the amount of total purchases required. The time of day condition set identifies a time period during which rewards may be received. The day of week condition set identifies the day(s) of the week on which the rewards may be received. Each condition set is programmed such that once conditions are met, rewards are issued for all qualifying items. While only one condition set type is allowed for each condition set, more than one condition set may contain the same condition set type. One skilled in the art can appreciate, however, that the number and type of condition sets may vary depending on the application. In one embodiment, seven (7) condition sets may be defined. When multiple condition sets are specified, all of the conditions in each set must be met in order to receive the corresponding rewards.

A representative sample of the plurality of reward parameters available through system 10 is identified in tabular format below.

| XML Element/Attribute | | Max | | | |
|---|---|---|---|---|---|
| Tag | Data Type | Len | Occur | Usage | Description |
| /SOX/Offer/OfferMaintReq/ | Aggregate | 0 | Once | Optional | Offer Rewards: |
| OfferRewards | | | | | Encapsulates the Rewards |
| | | | | | applicable to @OfferID. |
| | | | | | This element is required when |
| | | | | | /SOX/Offer/@Action = “Add” or |
| | | | | | “Replace”. |
| | | | | | It is not required when |
| | | | | | /SOX/Offer/@Action = “Delete”. |
| . . . /@RewardSetCount | String | 1 | Once | Required | Reward Set Count: |
| | | | | | Number of Reward Set instances |
| | | | | | in this document. |
| | | | | | Value = 1-7 |
| . . . /RewardSet[ ] | Aggregate | 0 | One | Required | Reward Set: |
| | List | | or | | Encapsulates the details of a |
| | | | Many | | single Reward Set. This element |
| | | | | | must contain only one of the |
| | | | | | following available Reward Set |
| | | | | | type elements: |
| | | | | | ItemDiscount |
| | | | | | DeptDiscount |
| | | | | | TotalDiscount |
| | | | | | FreeItem |
| | | | | | ReplacementPriceMethod1 |
| . . . /RewardSet[ ]/@RewardSetID | Enumerated | 1 | Once | Required | Reward Set ID: |
| | String | | | | Value = 0-7 |
| | | | | | Value must be mutually exclusive |
| | | | | | with other @RewardSetID values |
| | | | | | and |
| | | | | | /SOX/Offer/OfferMaintReq/OfferConditions/ |
| | | | | | ConditionSet[ ]/@ConditionSetID |
| | | | | | values. |
| . . . /RewardSet[ ]/ItemDiscount | Aggregate | 0 | Once | Optional | Item Discount: |
| | | | | | Element which encapsulates the |
| | | | | | details of the ItemDiscount |
| | | | | | Reward Set type. |
| . . . /RewardSet[ ]/ItemDiscount/ | Enumerated | 7 | Once | Required | Basis: |
| @Basis | String | | | | Defines the basis on which |
| | | | | | Rewards will be given: |
| | | | | | Valid values: |
| | | | | | “Percent” = Percentage off. |
| | | | | | “Amount” = Amount off. |
| . . . /RewardSet[ ]/ItemDiscount/ | Aggregate | 0 | Once | Required | Item List: |
| ItemList | | | | | Element encapsulating the items |
| | | | | | that may receive this Reward. |
| . . . /RewardSet[ ]/ItemDiscount/ | String | 4 | Once | Required | Item Count: |
| ItemList/@ItemCount | | | | | The number of . . . ItemList/Item[ ] |
| | | | | | entries to follow. |
| | | | | | Value = 1-9999 |
| . . . /RewardSet[ ]/ItemDiscount/ | String | 12 | One | Required | Item: |
| ItemList/Item[ ] | List | | or | | UPC/EAN Code of eligible item |
| | | | Many | | without the check digit. All 12 |
| | | | | | digits must be specified even if |
| | | | | | leading zero's are needed. |
| | | | | | Compressed UPC is not permitted. |
| . . . /RewardSet[ ]/ItemDiscount/ | String | 2 | Once | Required | Reward Limit: |
| RewardLimit | | | | | Maximum number of Rewards which |
| | | | | | can be issued each time the |
| | | | | | Conditions of the Offer are met. |
| | | | | | Value = 1-9, or −1 |
| | | | | | (=unlimited). |
| . . . /RewardSet[ ]/ItemDiscount/ | String | 10 | Once | Required | Basis Value: |
| BasisValue | | | | | Metric of . . . /ItemDiscount/@Basis |
| | | | | | to be applied. |
| | | | | | If . . . /ItemDiscount/@Basis = |
| | | | | | Percent, then the value is the |
| | | | | | percentage discount in whole |
| | | | | | numbers. |
| | | | | | Value = 1-99 |
| | | | | | If . . . /ItemDiscount/@Basis = |
| | | | | | Amount, then the value is the |
| | | | | | discount amount in cents. |
| | | | | | Value = 1-2147483647 |
| | | | | | Note that the price of an item |
| | | | | | will never be reduced below |
| | | | | | zero. |
| . . . /RewardSet[ ]/DeptDiscount | Aggregate | 0 | Once | Optional | Department Discount: |
| | | | | | Element which encapsulates the |
| | | | | | details of the DeptDiscount |
| | | | | | Reward Set type. |
| | | | | | The Offer Distributor is |
| | | | | | responsible for the correct |
| | | | | | identification of departments. |
| | | | | | It is recommended that only the |
| | | | | | store operator uses this Reward |
| | | | | | Set type. |
| . . . /RewardSet[ ]/DeptDiscount/ | Enumerated | 7 | Once | Required | Basis: |
| @Basis | String | | | | Defines the basis on which |
| | | | | | Rewards will be given: |
| | | | | | Valid values: |
| | | | | | “Percent” = Percentage off. |
| | | | | | “Amount” = Amount off. |
| . . . /RewardSet[ ]/DeptDiscount/ | Aggregate | 0 | Once | Required | Department List: |
| DeptList | | | | | Element encapsulating the store |
| | | | | | departments whose items are |
| | | | | | eligible to receive this Reward. |
| . . . /RewardSet[ ]/DeptDiscount/ | String | 4 | Once | Required | Department Count: |
| DeptList/@DeptCount | | | | | The number of . . . DeptList/Dept[ ] |
| | | | | | entries to follow. |
| | | | | | Value = 1-9999 |
| . . . /RewardSet[ ]/DeptDiscount/ | String | 4 | One | Required | Department: |
| DeptList/Dept[ ] | List | | or | | Store department whose items are |
| | | | Many | | eligible to receive this Reward. |
| | | | | | Value = 1-9999 |
| . . . /RewardSet[ ]/DeptDiscount/ | String | 2 | Once | Required | Reward Limit: |
| RewardLimit | | | | | Maximum number of Rewards which |
| | | | | | can be issued each time the |
| | | | | | Conditions of the Offer are met. |
| | | | | | Value = 1-9, or −1 (= |
| | | | | | unlimited). |
| . . . /RewardSet[ ]/DeptDiscount/ | String | 10 | Once | Required | Basis Value: |
| BasisValue | | | | | Metric of . . . /DeptDiscount/@Basis |
| | | | | | to be applied. |
| | | | | | If . . . /DeptDiscount/@Basis = |
| | | | | | Percent, then the value is the |
| | | | | | percentage discount in whole |
| | | | | | numbers. |
| | | | | | Value = 1-99 |
| | | | | | If . . . /DeptDiscount/@Basis = |
| | | | | | Amount, then the value is the |
| | | | | | discount amount in cents. |
| | | | | | Value = 1-2147483647 |
| | | | | | Note that the total value of |
| | | | | | purchases of items in eligible |
| | | | | | departments will never be |
| | | | | | reduced below zero. |
| . . . /RewardSet[ ]/TotalDiscount | Aggregate | 0 | Once | Optional | Total Discount: |
| | | | | | Element which encapsulates the |
| | | | | | details of the TotalDiscount |
| | | | | | Reward Set type. |
| . . . /RewardSet[ ]/TotalDiscount/ | Enumerated | 7 | Once | Required | Basis: |
| @Basis | String | | | | Defines the basis on which |
| | | | | | Rewards will be given: |
| | | | | | Valid values: |
| | | | | | “Percent” = Percentage off. |
| | | | | | “Amount” = Amount off. |
| . . . /RewardSet[ ]/TotalDiscount/ | String | 2 | Once | Required | Reward Limit: |
| RewardLimit | | | | | Maximum number of Rewards which |
| | | | | | can be issued each time the |
| | | | | | Conditions of the Offer are met. |
| | | | | | Value = 1-9, or −1 (= |
| | | | | | unlimited). |
| . . . /RewardSet[ ]/TotalDiscount/ | String | 10 | Once | Required | Basis Value: |
| BasisValue | | | | | Metric of |
| | | | | | . . . /TotalDiscount/@Basis to be |
| | | | | | applied. |
| | | | | | If . . . /TotalDiscount/@Basis = |
| | | | | | Percent, then the value is the |
| | | | | | percentage discount in whole |
| | | | | | numbers. |
| | | | | | Value = 1-99 |
| | | | | | If . . . /TotalDiscount/@Basis = |
| | | | | | Amount, then the value is the |
| | | | | | discount amount in cents. |
| | | | | | Value = 1-2147483647 |
| | | | | | Note that the total value of |
| | | | | | purchases will never be reduced |
| | | | | | below zero. |
| . . . /RewardSet[ ]/FreeItem | Aggregate | 0 | Once | Optional | Free Item: |
| | | | | | Element which encapsulates the |
| | | | | | details of the FreeItem Reward |
| | | | | | Set type. |
| . . . /RewardSet[ ]/FreeItem/ | Aggregate | 0 | Once | Required | Item List: |
| ItemList | | | | | Element encapsulating the items |
| | | | | | that may receive this Reward. |
| . . . /RewardSet[ ]/FreeItem/ | String | 4 | Once | Required | Item Count: |
| ItemList/@ItemCount | | | | | The number of . . . ItemList/Item[ ] |
| | | | | | entries to follow. |
| | | | | | Value = 1-9999 |
| . . . /RewardSet[ ]/FreeItem/ | String | 12 | One | Required | Item: |
| ItemList/Item[ ] | List | | or | | UPC/EAN Code of eligible item |
| | | | Many | | without the check digit. All 12 |
| | | | | | digits must be specified even if |
| | | | | | leading zero's are needed. |
| | | | | | Compressed UPC is not permitted. |
| . . . /RewardSet[ ]/FreeItem/ | String | 2 | Once | Required | Reward Limit: |
| RewardLimit | | | | | Maximum number of Rewards which |
| | | | | | can be issued each time the |
| | | | | | Conditions of the Offer are met. |
| | | | | | Value = 1-9, or −1 (= |
| | | | | | unlimited). |
| . . . /RewardSet[ ]/ | Aggregate | 0 | Once | Optional | Replacement Price Method 1: |
| ReplacementPriceMethod1 | | | | | Element which encapsulates the |
| | | | | | details of the |
| | | | | | ReplacementPriceMethod1 Reward |
| | | | | | Set type. |
| | | | | | The replacement price to be |
| | | | | | applied follows IBM 4690 |
| | | | | | Supermarket Application pricing |
| | | | | | method 1 logic. Pricing methods |
| | | | | | 0, 2, 3, and 4 may be supported |
| | | | | | in future versions of the |
| | | | | | system, if required. |
| | | | | | This Reward Set type may not be |
| | | | | | used for weighed or NSC 02 |
| | | | | | items. |
| . . . /RewardSet[ ]/ | Aggregate | 0 | Once | Required | Item List: |
| ReplacementPriceMethod1/ | | | | | Element encapsulating the items |
| ItemList | | | | | that may receive this Reward. |
| . . . /RewardSet[ ]/ | String | 4 | Once | Required | Item Count: |
| ReplacementPriceMethod1/ | | | | | The number of . . . ItemList/Item[ ] |
| ItemList/@ItemCount | | | | | entries to follow. |
| | | | | | Value = 1-9999 |
| . . . /RewardSet[ ]/ | String | 12 | One | Required | Item: |
| ReplacementPriceMethod1/ | List | | or | | UPC/EAN Code of eligible item |
| ItemList/Item[ ] | | | Many | | without the check digit. All 12 |
| | | | | | digits must be specified even if |
| | | | | | leading zero's are needed. |
| | | | | | Compressed UPC is not permitted. |
| . . . /RewardSet[ ]/ | String | 8 | Once | Required | Deal Price: |
| ReplacementPriceMethod1/ | | | | | Total price, in cents, of |
| DealPrice | | | | | DealQuantity units. |
| | | | | | Value = 1-99999999 |
| . . . /RewardSet[ ]/ | String | 2 | Once | Required | Deal Quantity: |
| ReplacementPriceMethod1/ | | | | | Number of units received for |
| DealQuantity | | | | | DealPrice. |
| | | | | | Value = 1-99 |
| . . . /RewardSet[ ]/ | String | 2 | Once | Required | Reward Limit: |
| ReplacementPriceMethod1/ | | | | | Maximum number of Rewards which |
| RewardLimit | | | | | can be issued each time the |
| | | | | | Conditions of the Offer are met. |
| | | | | | Value = 1-9, or −1 (= |
| | | | | | unlimited). |

Rewards are the benefits received by the customers when the conditions are met. The reward(s) associated with an offer are defined by a plurality of rewards sets. In one embodiment, there are five (5) reward set types, namely the item discount reward, the department discount reward, the total discount reward, the free item reward and the replacement price reward. One skilled in the art can appreciate, however, that the number and type of rewards may vary depending on the application. For example, rewards can be deferred to a third party, such as deposits directly into a mutual fund or a child's college fund.

The item discount reward is applied to the price of a specific item or item(s). The department discount reward is applied to the price of items in a certain department or departments. The total discount reward is applied to the total price of a customer's total purchases. The free item reward is applied to reduce the price of a specific item or items to zero. The replacement price reward is applied to replace an existing price for a specific item or items. While only one reward set type is allowed for each reward set, more than one reward set may contain the same reward set type. When multiple reward sets are specified, all possible rewards are given if the corresponding conditions are met.

Once the offers have been created, they are routed to the appropriate store or stores in which they are valid for redemption. A preferred format for offer store routing is provided below.

| XML Element/Attribute | | Max | | | |
|---|---|---|---|---|---|
| Tag | Data Type | Len | Occur | Usage | Description |
| /SOX/Offer/OfferRouteReq | Aggregate | 0 | Once | Optional | Offer Route Request: |
| | | | | | Encapsulates all Offer store |
| | | | | | routing requests. |
| . . . /StoreList[ ] | Aggregate | 0 | One | Required | Store List: |
| | List | | or | | Encapsulates details of all |
| | | | Many | | stores for which the same |
| | | | | | @Action is required for this |
| | | | | | @OfferID. |
| . . . /StoreList[ ]/@Action | Enumerated | 7 | Once | Required | Action: |
| | String | | | | Defines maintenance |
| | | | | | operation to be performed |
| | | | | | for this @Offer for this |
| | | | | | StoreList[ ]. |
| | | | | | Valid values: |
| | | | | | Add |
| | | | | | Replace |
| | | | | | Delete |
| . . . /StoreList[ ]/@StoreCount | String | 10 | Once | Required | Store Count: |
| | | | | | The number of |
| | | | | | . . . /StoreList/Store[ ] entries |
| | | | | | to follow. |
| | | | | | Value = 1-2147483647 |
| . . . /StoreList[ ]/Store[ ] | Aggregate | 0 | One | Required | Store: |
| | List | | or | | Encapsulates the details of |
| | | | Many | | one store. |
| . . . /StoreList[ ]/Store[ ]/ | String | 10 | Once | Required | Store ID: |
| StoreID | | | | | Assigned by ECN. |
| | | | | | Unique Store Identifier. |
| | | | | | Valid value: 1-2147483647 |
| . . . /StoreList[ ]/Store[ ]/ | String | 2 | Once | Required | Service Priority: |
| ServicePriority | | | | | Indicates maximum processing |
| | | | | | delay for requested routing |
| | | | | | service. |
| | | | | | Supported values for the |
| | | | | | Pilot: |
| | | | | | “ON” = Overnight |
| | | | | | Beyond Pilot: |
| | | | | | “RT” = Real-time |
| | | | | | “15” = 15 Minutes |
| | | | | | “HR” = 1 Hour |

The OfferRouteReq parameter encapsulates all offer store routing requests. The Storelist parameter encapsulates the details of all stores for which the same maintenance action is required for a particular offer. In particular, the @Action parameter defines the particular maintenance action to be performed for the list of stores identified by the Storelist parameter. The Storecount parameter identifies the number of stores to which to apply said action. The Store parameter encapsulates the details of one store, namely the identification value assigned to the store by network 13. The ServicePriority parameter identifies the maximum processing delay for the requested routing service (i.e., overnight, real-time, or set-time).

In a preferred embodiment, customer-specific variations can be introduced with respect to an offer through the CustomerOffer document type, which has the same header format as that for the Offer document type, with the value of the @SOXType parameter being “CustomerOffer.” A customer offer contains replacement values for some of the offer properties and rewards that are “overlaid” on top of the “generic” offer values when a customer identifies himself or herself at the time of purchase, such as through a loyalty card. A preferred format for the maintenance, the offer properties, rewards and offer routing for the Customer Offer document type are similar to that for an Offer document type and are identified in tabular format below, respectively.

### Customer Offer Maintenance Request

| XML Element/Attribute | | Max | | | |
|---|---|---|---|---|---|
| Tag | Data Type | Len | Occur | Usage | Description |
| /SOX/CustomerOffer[ ] | Aggregate | 0 | One | Required | Customer Offer: |
| | | | or | Always | The /SOX/CustomerOffer[ ] |
| | | | Many | | aggregate element may contain: |
| | | | | | One |
| | | | | | /SOX/CustomerOffer[ ]/CustOfferMaint |
| | | | | | Req aggregate element and one |
| | | | | | /SOX/CustomerOffer[ ]/CustOfferRoute |
| | | | | | Req aggregate element; |
| | | | | | OR |
| | | | | | One |
| | | | | | /SOX/CustomerOffer[ ]/CustOfferMaint |
| | | | | | Req aggregate element only; |
| | | | | | OR |
| | | | | | One |
| | | | | | /SOX/CustomerOffer[ ]/CustOfferRoute |
| | | | | | Req aggregate element only. |
| . . . /@OfferID | String | 12 | Once | Required | Offer ID: |
| | | | | Always | Number is provided by offer |
| | | | | | distributor and must be unique |
| | | | | | for that distributor. |
| | | | | | Value = 1-999999999999 |
| . . . /@MerchantID | String | 10 | Once | Required | Merchant ID: |
| | | | | Always | Assigned by ECN. |
| | | | | | Identifies the issuing |
| | | | | | organization for the Customer's |
| | | | | | loyalty card. |
| | | | | | Value: 1-2147483647 |
| . . . /@CustomerID | String | 18 | Once | Required | Customer ID: |
| | | | | Always | Normally, the Customer's loyalty |
| | | | | | card number for the merchant |
| | | | | | represented by @MerchantID. |
| . . . /CustOfferMaintReq | Aggregate | 0 | Once | Optional | Customer Offer Maintenance |
| | | | | | Request: |
| | | | | | Encapsulates CustomerOffer |
| | | | | | maintenance request details for |
| | | | | | @OfferID and |
| | | | | | @MerchantID/@CustomerID above. |
| . . . /CustOfferMaintReq/ | Enumerated | 8 | Once | Required | Action: |
| @Action | String | | | | CustomerOffer maintenance action |
| | | | | | requested. |
| | | | | | Valid values: |
| | | | | | Add |
| | | | | | Replace |
| | | | | | Delete |
| | | | | | Activate |

### Customer Offer Properties

| XML Element/Attribute | | Max | | | |
|---|---|---|---|---|---|
| Tag | Data Type | Len | Occur | Usage | Description |
| /SOX/CustomerOffer[ ]/ | Aggregate | 0 | | Optional | CustomerOffer Properties: |
| CustOfferMaintReq/ | | | | | Contains CustomerOffer |
| CustOfferProperties | | | | | Properties for @OfferID for |
| | | | | | @MerchantID/@CustomerID above. |
| | | | | | This element is required when |
| | | | | | /SOX/CustomerOffer[ ]/@Action = |
| | | | | | “Add” or “Replace” or |
| | | | | | “Activate”. |
| | | | | | It is not required when |
| | | | | | /SOX/CustomerOffer[ ]/@Action = |
| | | | | | “Delete”. |
| . . . /CustOfferXactLimit | String | 2 | Once | Required | Customer Offer Transaction |
| | | | | | Limit: |
| | | | | | Maximum number of times this |
| | | | | | offer may be used per |
| | | | | | transaction. |
| | | | | | Value = 0-9, or -1 (= |
| | | | | | unlimited). |
| | | | | | If value = 0, this |
| | | | | | CustomerOffer is not active. |
| . . . /CustOfferCustLimit | String | 2 | Once | Required | Customer Offer Customer Limit: |
| | | | | | Total number of times this |
| | | | | | offer may be used, across |
| | | | | | transactions. |
| | | | | | Value = 0-9, or -1 (= |
| | | | | | unlimited). |

### Customer Offer Rewards

| XML Element/Attribute | | Max | | | |
|---|---|---|---|---|---|
| Tag | Data Type | Len | Occur | Usage | Description |
| /SOX/CustomerOffer[ ]/ | Aggregate | 0 | Once | Optional | CustomerOffer Rewards: |
| CustOfferMaintReq/ | | | | | Contains CustomerOffer Rewards |
| CustOfferRewards | | | | | for @OfferID for |
| | | | | | @MerchantID/@CustomerID above. |
| | | | | | This element is required when |
| | | | | | /SOX/CustomerOffer[ ]/@Action = |
| | | | | | “Add” or “Replace”. |
| | | | | | It is not required when |
| | | | | | /SOX/CustomerOffer[ ]/@Action = |
| | | | | | “Delete” or “Activate”. |
| . . . /@RewardSetCount | String | 1 | Once | Required | Reward Set Count: |
| | | | | | Number of Reward Set instances |
| | | | | | in this CustomerOffer[ ]. |
| | | | | | Value = 1-7 |
| . . . /RewardSet[ ] | Aggregate | 0 | One | Required | Reward Set: |
| | List | | or | | Encapsulates the details of a |
| | | | Many | | single Reward Set. This |
| | | | | | element must contain only one |
| | | | | | of the following available |
| | | | | | Reward Set type elements: |
| | | | | | ItemDiscount |
| | | | | | DeptDiscount |
| | | | | | TotalDiscount |
| | | | | | ReplacementPriceMethod1 |
| | | | | | Note that CustOfferRewards for |
| | | | | | FreeItem are not meaningful. |
| . . . /RewardSet[ ]/@RewardSetID | Enumerated | 1 | Once | Required | Reward Set ID: |
| | String | | | | Value = 0-7 |
| | | | | | Value is determined by the |
| | | | | | @RewardSetID from the global |
| | | | | | @OfferID which is to be |
| | | | | | overlaid with the data in this |
| | | | | | RewardSet[ ]. |
| | | | | | Additionally, the @RewardSetID |
| | | | | | must refer to the same Reward |
| | | | | | Set type and be measured on |
| | | | | | the same @Basis as the global |
| | | | | | @OfferID, or an error will |
| | | | | | result. |
| | | | | | The system cannot successfully |
| | | | | | overlay the customer-specific |
| | | | | | data values onto the global |
| | | | | | Offer unless they are |
| | | | | | comparable. |
| . . . /RewardSet[ ]/ItemDiscount | Aggregate | 0 | Once | Optional | Item Discount: |
| | | | | | Element which encapsulates the |
| | | | | | details of the ItemDiscount |
| | | | | | Reward Set type. |
| . . . /RewardSet[ ]/ItemDiscount/ | Enumerated | 7 | Once | Required | Basis: |
| @Basis | String | | | | Defines the basis on which |
| | | | | | Rewards will be given: |
| | | | | | Valid values: |
| | | | | | “Percent” = Percentage off. |
| | | | | | “Amount” = Amount off. |
| | | | | | See comments above regarding |
| | | | | | the need for compatibility |
| | | | | | with default rewards. |
| . . . /RewardSet[ ]/ItemDiscount/ | String | 10 | Once | Required | Basis Value: |
| BasisValue | | | | | Metric of |
| | | | | | . . . /ItemDiscount/@Basis to be |
| | | | | | applied. |
| | | | | | If . . . /ItemDiscount/@Basis = |
| | | | | | Percent, then the value is the |
| | | | | | percentage discount in whole |
| | | | | | numbers. |
| | | | | | Value = 1-99 |
| | | | | | If . . . /ItemDiscount/@Basis = |
| | | | | | Amount, then the value is the |
| | | | | | discount amount in cents. |
| | | | | | Value = 1-2147483647 |
| | | | | | Note that the price of an item |
| | | | | | will never be reduced below |
| | | | | | zero. |
| . . . /RewardSet[ ]/DeptDiscount | Aggregate | 0 | Once | Optional | Department Discount: |
| | | | | | Element which encapsulates the |
| | | | | | details of the DeptDiscount |
| | | | | | Reward Set type. |
| . . . /RewardSet[ ]/ | Enumerated | 7 | Once | Required | Basis: |
| DeptDiscount/ | String | | | | Defines the basis on which Rewards will |
| @Basis | | | | | be given: |
| | | | | | Valid values: |
| | | | | | “Percent” = Percentage off. |
| | | | | | “Amount” = Amount off. |
| | | | | | See comments above regarding the need |
| | | | | | for compatibility with default rewards. |
| . . . /RewardSet[ ]/DeptDiscount/ | String | 10 | Once | Required | Basis Value: |
| BasisValue | | | | | Metric of |
| | | | | | . . . /ItemDiscount/@Basis to be |
| | | | | | applied. |
| | | | | | If . . . /ItemDiscount/@Basis = |
| | | | | | Percent, then the value is the |
| | | | | | percentage discount in whole |
| | | | | | numbers. |
| | | | | | Value = 1-99 |
| | | | | | If . . . /ItemDiscount/@Basis = |
| | | | | | Amount, then the value is the |
| | | | | | discount amount in cents. |
| | | | | | Value = 1-2147483647 |
| | | | | | Note that the price of an item |
| | | | | | will never be reduced below |
| | | | | | zero. |
| . . . /RewardSet[ ]/DiscountTotal | Aggregate | 0 | Once | Optional | Total Discount: |
| | | | | | Element which encapsulates the |
| | | | | | details of the TotalDiscount |
| | | | | | Reward Set type. |
| . . . /RewardSet[ ]/TotalDiscount/ | Enumerated | 8 | Once | Required | Basis: |
| @Basis | String | | | | Defines the basis on which |
| | | | | | Rewards will be given: |
| | | | | | Valid values: |
| | | | | | “Percent” = Percentage off. |
| | | | | | “Amount” = Amount off. |
| | | | | | See comments above regarding |
| | | | | | the need for compatibility |
| | | | | | with default rewards. |
| . . . /RewardSet[ ]/TotalDiscount/ | String | 10 | Once | Required | Basis Value: |
| BasisValue | | | | | Metric of |
| | | | | | . . . /ItemDiscount/@Basis to be |
| | | | | | applied. |
| | | | | | If . . . /ItemDiscount/@Basis = |
| | | | | | Percent, then the value is the |
| | | | | | percentage discount in whole |
| | | | | | numbers. |
| | | | | | Value = 1-99 |
| | | | | | If . . . /ItemDiscount/@Basis = |
| | | | | | Amount, then the value is the |
| | | | | | discount amount in cents. |
| | | | | | Value = 1-2147483647 |
| | | | | | Note that the price of an item |
| | | | | | will never be reduced below |
| | | | | | zero. |
| . . . /RewardSet[ ]/ | Aggregate | 0 | Once | Optional | Replacement Price Method 1: |
| ReplacementPriceMethod1 | | | | | Element which encapsulates the |
| | | | | | details of the |
| | | | | | ReplacementPriceMethod1 Reward |
| | | | | | Set type. |
| . . . /RewardSet[ ]/ | String | 8 | Once | Required | Deal Price: |
| ReplacementPriceMethod1/ | | | | | Total price, in cents, of |
| DealPrice | | | | | DealQuantity units, where |
| | | | | | DealQuantity is defined in the |
| | | | | | default Rewards for @OfferID. |
| | | | | | Value = 1-99999999 |

### Customer Offer Store Routing

| XML Element/Attribute | | Max | | | |
|---|---|---|---|---|---|
| Tag | Data Type | Len | Occur | Usage | Description |
| /SOX/CustomerOffer[ ]/ | Aggregate | 0 | Once | Optional | CustomerOffer Route Request: |
| CustOfferRouteReq | | | | | Encapsulates CustomerOffer[ ] |
| | | | | | store routing request details. |
| . . . /StoreList[ ] | Aggregate | 0 | One | Required | Store List: |
| | List | | or | | Encapsulates details of all |
| | | | Many | | stores for which the same |
| | | | | | @Action is required for this |
| | | | | | @OfferID and |
| | | | | | @MerchantID/@CustomerID. |
| . . . /StoreList[ ]/@Action | Enumerated | 7 | Once | Required | Action: |
| | String | | | | Defines maintenance operation |
| | | | | | to be performed for this |
| | | | | | StoreList[ ]. |
| | | | | | Valid values: |
| | | | | | Add |
| | | | | | Replace |
| | | | | | Delete |
| | | | | | Activate |
| . . . /StoreList[ ]/@StoreCount | String | 10 | Once | Required | Store Count: |
| | | | | | The number of |
| | | | | | . . . /StoreList/Store[ ] entries |
| | | | | | to follow. |
| | | | | | Value = 1-2147483647 |
| . . . /StoreList[ ]/Store[ ] | Aggregate | 0 | One | Required | Store: |
| | List | | or | | Encapsulates the details of |
| | | | Many | | one store. |
| . . . /StoreList[ ]/Store[ ]/ | String | 10 | Once | Required | Store ID: |
| StoreID | | | | | Assigned by ECN. |
| | | | | | Unique Store Identifier. |
| | | | | | Valid value: 1-2147483647 |
| . . . /StoreList[ ]/Store[ ]/ | String | 2 | Once | Required | Service Priority: |
| | | | | | Indicates maximum processing |
| ServicePriority | | | | | delay for requested routing |
| | | | | | service. |
| | | | | | Supported values for the |
| | | | | | Pilot: |
| | | | | | “15” = 15 Minutes |
| | | | | | “HR” = 1 Hour |
| | | | | | “ON” = Overnight |
| | | | | | “RT” = Real-time |

As previously mentioned, the OfferAck document type is the positive acknowledgement returned by network 13 upon its successful processing of an offer document type. A preferred format for this type of document, including its header, is identified in a tabular format as shown below.

Header

| XML Element/Attribute | | Max | | | |
|---|---|---|---|---|---|
| Tag | Data Type | Len | Occur | Usage | Description |
| /SOX | Aggregate | 0 | Once | Required | Document Root Element: |
| | | | | Always | Identifies this as a SOX XML |
| | | | | | document. |
| . . . /@Version | String | 3 | Once | Required | SOX Version of File: |
| | | | | Always | Version of SOX to which this |
| | | | | | document conforms. |
| | | | | | Value = 1.0 |
| . . . /@SOXType | Enumerated | 8 | Once | Required | Sox Type: |
| | String | | | Always | Indicates type of SOX XML |
| | | | | | document. All SOX documents |
| | | | | | have this attribute with |
| | | | | | appropriate values. |
| | | | | | Value = OfferAck |

### Offer Document Acknowledgement.

| XML Element/Attribute | | Max | | | |
|---|---|---|---|---|---|
| Tag | Data Type | Len | Occur | Usage | Description |
| /SOX/OfferAck | Aggregate | 0 | Once | Required | Offer Acknowledgement: |
| | | | | | Encapsulates the acknowledgement |
| | | | | | of the receipt of the Offer |
| | | | | | document. |
| . . . /DistributorID | String | 10 | Once | Required | Distributor ID: |
| | | | | | @OfferDistributorID in the Offer |
| | | | | | document. |
| . . . /AckRequested | Enumerated | 7 | Once | Required | Acknowledgement Requested: |
| | String | | | | @AckRequested in the Offer |
| | | | | | document. |
| . . . /SenderDocUID | String | 12 | Once | Required | Sender's Document Unique ID: |
| | | | | | @SenderDocUID in the Offer |
| | | | | | document. |
| . . . /SessionID | String | 12 | Once | Required | Session ID: |
| | | | | | Generated by ECN. |
| | | | | | ECN ID for the session in which |
| | | | | | the Offer document was |
| | | | | | transmitted to the ECN. |
| | | | | | May be used for audit trail |
| | | | | | purposes. |
| . . . /OffRcptCtrlID | String | 10 | Once | Required | Offer Receipt Control ID: |
| | | | | | Generated by ECN. |
| | | | | | ECN identifier used for tracking |
| | | | | | the Offer document. |
| . . . /SenderID | String | 8 | Once | Required | Sender ID: |
| | | | | | Generated by ECN. |
| | | | | | ECN user ID under which the |
| | | | | | Offer document was transmitted |
| | | | | | to the ECN. |
| . . . /Date | Aggregate | 0 | Once | Required | Date: |
| | | | | | Generated by ECN. |
| | | | | | Date of OfferAck creation. |
| . . . /Date/Year | String | 4 | Once | Required | Year: |
| | | | | | Format: CCYY |
| . . . /Date/Month | String | 2 | Once | Required | Month: |
| | | | | | Format: MM |
| . . . /Date/Day | String | 2 | Once | Required | Day: |
| | | | | | Format: DD |
| . . . /Time | Aggregate | 0 | Once | Required | Time: |
| | | | | | Generated by ECN. |
| | | | | | Time of OfferAck creation. |
| . . . /Time/Hour | String | 2 | Once | Required | Hour: |
| | | | | | Format: HH |
| . . . /Time/Minute | String | 2 | Once | Required | Minute: |
| | | | | | Format: MM |
| . . . /Time/Second | String | 2 | Once | Required | Second: |
| | | | | | Format: SS |
| . . . /TimeZone | String | 3 | Once | Required | Time Zone: |
| | | | | | Generated by ECN. |
| | | | | | Time Zone for OfferAck creation |
| | | | | | timestamp. |

With respect to the Offer Document Acknowledgement format, the DistributorID parameter identifies a unique identification value for the offer distributor distributing the offer. The AckRequested parameter reflects the requested level of acknowledgement identified in the @AckRequested parameter of the header of the Offer document. The SenderDocUID parameter identifies the unique code identifying the XML document to its sender for audit trail purposes. The SessionID parameter is a unique identification value generated by network 13 identifying the session in which the Offer document was transmitted to it, and may also be used for audit trail purposes. The OffRcptCtrlID parameter is a unique identifier generated by network 13 for tracking the Offer document. The SenderID parameter is a unique identifier generated by network 13 representing the identity of the sender of the offer document under which the Offer document was transmitted to network 13. The Date and Time parameters are generated by the network 13 and identify the date and time, respectively, of the creation of the OfferAck document. A preferred format for the Offer Maintenance Request Acknowledgment and Offer Store Routing Acknowledgement identified in tabular format below.

Offer Maintenance Request Acknowledgement

| XML Element/Attribute | | Max | | | |
|---|---|---|---|---|---|
| Tag | Data Type | Len | Occur | Usage | Description |
| /SOX/Offer | Aggregate | 0 | Once | Required | Offer: |
| | | | | | Encapsulates results of Offer |
| | | | | | processing. |
| . . . /@OfferID | String | 12 | Once | Required | Offer ID: |
| | | | | | @OfferID in the Offer document. |
| . . . /OfferMaintReq | Aggregate | 0 | Once | Optional | Offer Maintenance Request: |
| | | | | | This element will exist if it |
| | | | | | was present in the processed |
| | | | | | Offer document. |
| | | | | | Encapsulates results of Offer |
| | | | | | maintenance processing. |
| . . . /OfferMaintReq/@Action | Enumerated | 7 | Once | Required | Action: |
| | String | | | | @Action in the Offer document. |
| /SOX/Offer/OfferMaintReq/ | Aggregate | 0 | | Optional | Offer Properties: |
| | | | | | This element will exist if it |
| OfferProperties | | | | | was present in the processed |
| | | | | | Offer document. |
| | | | | | Encapsulates results of Offer |
| | | | | | Properties processing. |
| . . . /Status | String | 9 | Once | Required | Status: |
| | | | | | Generated by ECN. |
| | | | | | Valid Values: |
| | | | | | Success |
| . . . /Result | Aggregate | 0 | Once | Required | Result: |
| | | | | | See result structure above. |
| /SOX/Offer/OfferMaint | Aggregate | 0 | Once | Optional | Offer Conditions: |
| Req/ | | | | | This element will exist if it |
| OfferConditions | | | | | was present in the processed |
| | | | | | Offer document. |
| | | | | | Encapsulates results of Offer |
| | | | | | Conditions processing. |
| . . . /@ConditionSetCount | String | 1 | Once | Required | Condition Set Count: |
| | | | | | Count of . . . /ConditionSet[ ] |
| | | | | | elements to follow. |
| . . . /ConditionSet[ ] | Aggregate | 0 | One | Required | Condition Set: |
| | List | | or | | Encapsulates the results of |
| | | | Many | | processing this @ConditionSetID. |
| . . . /ConditionSet[ ]/ | Enumerated | 1 | Once | Required | Condition Set ID: |
| @ConditionSetID | String | | | | @ConditionSetID in the Offer |
| | | | | | document. |
| . . . /ConditionSet[ ]/ | String | 9 | Once | Required | Status: |
| Status | | | | | Generated by ECN. |
| | | | | | Valid Values: |
| | | | | | Success |
| . . . /ConditionSet[ ]/ | Aggregate | 0 | Once | Required | Result: |
| Result | | | | | See result structure above. |
| /SOX/Offer/OfferMaintReq/ | Aggregate | 0 | Once | Optional | Offer Rewards: |
| OfferRewards | | | | | This element will exist if it |
| | | | | | was present in the processed |
| | | | | | Offer document. |
| | | | | | Encapsulates results of Offer |
| | | | | | Rewards processing. |
| . . . /@RewardSetCount | String | 1 | Once | Required | Reward Set Count: |
| | | | | | Count of . . . /RewardSet[ ] elements |
| | | | | | to follow. |
| . . . /RewardSet[ ] | Aggregate | 0 | One | Required | Reward Set: |
| | List | | or | | Encapsulates the results of |
| | | | Many | | processing this @RewardSetID. |
| . . . /RewardSet[ ]/ | Enumerated | 1 | Once | Required | Reward Set ID: |
| @RewardSetID | String | | | | @RewardSetID in the Offer |
| | | | | | document. |
| . . . /RewardSet[ ]/Status | String | 9 | Once | Required | Status: |
| | | | | | Generated by ECN. |
| | | | | | Valid Values: |
| | | | | | Success |
| . . . /RewardSet[ ]/Result | Aggregate | 0 | Once | Required | Result: |
| | | | | | See result structure above. |

### Offer Store Routing Acknowledgement.

| XML Element/Attribute | | Max | | | |
|---|---|---|---|---|---|
| Tag | Data Type | Len | Occur | Usage | Description |
| /SOX/Offer/OfferRouteReq | Aggregate | 0 | Once | Optional | Offer Routing Request: |
| | | | | | This element will exist if it |
| | | | | | was present in the processed |
| | | | | | Offer document. |
| | | | | | Encapsulates results of Offer |
| | | | | | routing processing. |
| . . . /StoreList[ ] | Aggregate | 0 | One | Required | Store List: |
| | List | | or | | Encapsulates the details of |
| | | | Many | | stores for which the same |
| | | | | | @Action is required. |
| . . . /StoreList[ ]/@Action | Enumerated | 7 | Once | Required | Action: |
| | String | | | | @Action in the Offer document. |
| . . . /StoreList[ ]/@StoreCount | String | 10 | Once | Required | Store Count: |
| | | | | | Count of . . . /Store[ ] elements to |
| | | | | | follow. |
| . . . /StoreList[ ]/Store[ ] | Aggregate | 0 | One | Required | Store: |
| | List | | or | | Encapsulates the details of one |
| | | | Many | | store. |
| . . . /StoreList[ ]/Store[ ]/ | String | 10 | Once | Required | Store ID: |
| StoreID | | | | | StoreID in the Offer document. |
| . . . /StoreList[ ]/Store[ ]/ | String | 2 | Once | Required | Service Priority: |
| ServicePriority | | | | | ServicePriority in the Offer |
| | | | | | document. |
| . . . /StoreList[ ]/Store[ ]/ | String | 9 | Once | Required | Status: |
| Status | | | | | Generated by ECN. |
| | | | | | Valid Values: |
| | | | | | Success |
| | | | | | Scheduled |
| . . . /StoreList[ ]/Store[ ]/ | Aggregate | 0 | Once | Required | Result: |
| Result | | | | | See result structure above. |

Likewise, a preferred format for the CustomerOfferAck document type (which has the same header format with a value for the @SOXType parameter being “CustomerOfferAck,” and includes Offer Document Acknowledgement, CustomerOffer Maintenance Request Acknowledgement and CustomerOffer Store Routing Acknowledgement are provided below.

Offer Document Acknowledgement

| XML Element/Attribute | | Max | | | |
|---|---|---|---|---|---|
| Tag | Data Type | Len | Occur | Usage | Description |
| /SOX/CustOfferAck | Aggregate | 0 | Once | Required | CustomerOffer Acknowledgement: |
| | | | | | Encapsulates the acknowledgement |
| | | | | | of the receipt of the |
| | | | | | CustomerOffer document. |
| . . . /DistributorID | String | 10 | Once | Required | Distributor ID: |
| | | | | | @OfferDistributorID in the |
| | | | | | CustomerOffer document. |
| . . . /AckRequested | Enumerated | 7 | Once | Required | Acknowledgement Requested: |
| | String | | | | @AckRequested in the |
| | | | | | CustomerOffer document. |
| . . . /SenderDocUID | String | 12 | Once | Required | Sender's Document Unique ID: |
| | | | | | @SenderDocUID in the |
| | | | | | CustomerOffer document. |
| . . . /SessionID | String | 12 | Once | Required | Session ID: |
| | | | | | Generated by ECN. |
| | | | | | ECN ID for the session in which |
| | | | | | the CustomerOffer document was |
| | | | | | transmitted to the ECN. May be |
| | | | | | used for audit trail purposes. |
| . . . /OffRcptCtrlID | String | 10 | Once | Required | Offer Receipt Control ID: |
| | | | | | Generated by ECN. |
| | | | | | ECN identifier used for tracking |
| | | | | | the CustomerOffer document. |
| . . . /SenderID | String | 8 | Once | Required | Sender ID: |
| | | | | | Generated by ECN. |
| | | | | | ECN user ID under which the |
| | | | | | CustomerOffer document was |
| | | | | | transmitted to the ECN. |
| . . . /Date | Aggregate | 0 | Once | Required | Date: |
| | | | | | Generated by ECN. |
| | | | | | Date of CustomerOfferAck |
| | | | | | creation. |
| . . . /Date/Year | String | 4 | Once | Required | Year: |
| | | | | | Format: CCYY |
| . . . /Date/Month | String | 2 | Once | Required | Month: |
| | | | | | Format: MM |
| . . . /Date/Day | String | 2 | Once | Required | Day: |
| | | | | | Format: DD |
| . . . /Time | Aggregate | 0 | Once | Required | Time: |
| | | | | | Generated by ECN. |
| | | | | | Time of CustomerOfferAck |
| | | | | | creation. |
| . . . /Time/Hour | String | 2 | Once | Required | Hour: |
| | | | | | Format: HH |
| . . . /Time/Minute | String | 2 | Once | Required | Minute: |
| | | | | | Format: MM |
| . . . /Time/Second | String | 2 | Once | Required | Second: |
| | | | | | Format: SS |
| . . . /TimeZone | String | 3 | Once | Required | Time Zone: |
| | | | | | Generated by ECN. |
| | | | | | Time Zone for CustomerOfferAck |
| | | | | | creation timestamp. |

### Customer Offer Maintenance Request Acknowledgement

| XML Element/Attribute | | Max | | | |
|---|---|---|---|---|---|
| Tag | Data Type | Len | Occur | Usage | Description |
| /SOX/CustomerOffer | Aggregate | 0 | One | Required | CustomerOffer: |
| | | | or | | Encapsulates results of |
| | | | Many | | CustomerOffer processing. |
| . . . /@OfferID | String | 12 | Once | Required | Offer ID: |
| | | | | | @OfferID in the CustomerOffer |
| | | | | | document. |
| . . . /@MerchantID | String | 10 | Once | Required | Merchant ID: |
| | | | | | @MerchantID in the CustomerOffer |
| | | | | | document. |
| . . . /@CustomerID | String | 18 | Once | Required | Customer ID: |
| | | | | | @CustomerID in the CustomerOffer |
| | | | | | document. |
| . . . /CustOfferMaintReq | Aggregate | 0 | Once | Optional | CustomerOffer Maintenance |
| | | | | | Request: |
| | | | | | This element will exist if it |
| | | | | | was present in the processed |
| | | | | | CustomerOffer document. |
| | | | | | Encapsulates results of |
| | | | | | CustomerOffer maintenance |
| | | | | | processing. |
| . . . /CustOfferMaintReq/ | Enumerated | 7 | Once | Required | Action: |
| @Action | String | | | | @Action in the CustomerOffer |
| | | | | | document. |
| /SOX/CustomerOffer/ | Aggregate | 0 | | Optional | CustomerOffer Properties: |
| CustOfferMaintReq/ | | | | | This element will exist if it |
| CustOfferProperties | | | | | was present in the processed |
| | | | | | CustomerOffer document. |
| | | | | | Encapsulates results of |
| | | | | | CustomerOffer Properties |
| | | | | | processing. |
| . . . /Status | String | 9 | Once | Required | Status: |
| | | | | | Generated by ECN. |
| | | | | | Valid Values: |
| | | | | | Success |
| . . . /Result | Aggregate | 0 | Once | Required | Result: |
| | | | | | See result structure above. |
| /SOX/CustomerOffer/ | Aggregate | 0 | Once | Optional | CustomerOffer Rewards: |
| CustOfferMaintReq/ | | | | | This element will exist if it |
| CustOfferRewards | | | | | was present in the processed |
| | | | | | CustomerOffer document. |
| | | | | | Encapsulates results of |
| | | | | | CustomerOffer Rewards |
| | | | | | Processing. |
| . . . /@RewardSetCount | String | 1 | Once | Required | Reward Set Count: |
| | | | | | Count of . . . /RewardSet[ ] elements |
| | | | | | to follow. |
| . . . /RewardSet[ ] . . . | Aggregate | 0 | One | Required | Reward Set: |
| | List | | or | | Encapsulates the results of |
| | | | Many | | processing this @RewardSetID. |
| . . . /RewardSet[ ]/@RewardSetID | Enumerated | 1 | Once | Required | Reward Set ID: |
| | String | | | | @RewardSetID in the |
| | | | | | CustomerOffer document. |
| . . . /RewardSet[ ]/Status | String | 9 | Once | Required | Status: |
| | | | | | Generated by ECN. |
| | | | | | Valid Values: |
| | | | | | Success |
| . . . /RewardSet[ ]/Result | Aggregate | 0 | Once | Required | Result: |
| | | | | | See result structure above. |

### Customer Offer Store Routing Acknowledgement

| XML Element/Attribute | | Max | | | |
|---|---|---|---|---|---|
| Tag | Data Type | Len | Occur | Usage | Description |
| /SOX/CustomerOffer/ | Aggregate | 0 | Once | Optional | CustomerOffer Routing Request: |
| CustOfferRouteReq | | | | | This element will exist if it |
| | | | | | was present in the processed |
| | | | | | CustomerOffer document. |
| | | | | | Encapsulates results of Offer |
| | | | | | routing processing. |
| . . . /StoreList[ ] | Aggregate | 0 | One | Required | Store List: |
| | List | | or | | Encapsulates the details of |
| | | | Many | | stores for which the same |
| | | | | | @Action is required. |
| . . . /StoreList[ ]/@Action | Enumerated | 7 | Once | Required | Action: |
| | String | | | | @Action in the CustomerOffer |
| | | | | | document. |
| . . . /StoreList[ ]/@StoreCount | String | 10 | Once | Required | Store Count: |
| | | | | | Count of . . . /Store[ ] elements to |
| | | | | | follow. |
| . . . /StoreList[ ]/Store[ ] | Aggregate | 0 | One | Required | Store: |
| | List | | or | | Encapsulates the details of one |
| | | | Many | | store. |
| . . . /StoreList[ ]/Store[ ]/ | String | 10 | Once | Required | Store ID: |
| StoreID | | | | | StoreID in the Offer document. |
| . . . /StoreList[ ]/Store[ ]/ | String | 2 | Once | Required | Service Priority: |
| ServicePriority | | | | | ServicePriority in the Offer |
| | | | | | document. |
| . . . /StoreList[ ]/Store[ ]/ | String | 9 | Once | Required | Status: |
| Status | | | | | Generated by ECN. |
| | | | | | Valid Values: |
| | | | | | Success |
| | | | | | Scheduled |
| . . . /StoreList[ ]/Store[ ]/ | Aggregate | 0 | Once | Required | Result: |
| Result | | | | | See result structure above. |

As previously mentioned, the ErrorResponse document type is the negative acknowledgement returned by the network 13 upon encountering an error in the course of processing an Offer or Customer Offer document type. ErrorResponse documents adhere to the DTD represented as SOXErrorResponse.dtd in Appendix 1. The header for this document type is the same as that for the OfferAck and CustomerOfferAck document types, with the exception that the value for @SOXType parameter is “ErrorResponse.” A preferred format for this document is shown in tabular format below.

| XML Element/Attribute | | Max | | | |
|---|---|---|---|---|---|
| Tag | Data Type | Len | Occur | Usage | Description |
| /SOX/ErrorResponse | Aggregate | 0 | Once | Required | Error Response: |
| | | | | | Encapsulates the acknowledgement |
| | | | | | of the receipt of the Offer or |
| | | | | | CustomerOffer document. |
| . . . /SenderDocUID | String | 12 | Once | Required | Sender's Document Unique ID: |
| | | | | | @SenderDocUID in the Offer or |
| | | | | | CustomerOffer document. |
| . . . /ErrorCode | String | 10 | Once | Required | Error Code: |
| | | | | | Generated by ECN. |
| | | | | | Assigned according to the type |
| | | | | | and source of the Error Code. |
| . . . /ErrorDescription | String | 255 | Once | Required | Error Description: |
| | | | | | Generated by ECN. |
| | | | | | The Error default text. |
| . . . /ErrorCondition | String | 255 | Once | Required | Error Condition: |
| | | | | | Generated by ECN. |
| | | | | | Used to further explain the |
| | | | | | conditions that cause this Error |
| | | | | | code. |
| . . . /ErrorMessage | String | 255 | Once | Required | Error Message: |
| | | | | | Generated by ECN. |
| . . . /ErrorSource | String | 255 | Once | Required | Error Source: |
| | | | | | Generated by ECN. |
| . . . /Date | Aggregate | 0 | Once | Required | Date: |
| | | | | | Generated by ECN. |
| | | | | | Date of ErrorResponse creation. |
| . . . /Date/Year | String | 4 | Once | Required | Year: |
| | | | | | Format: CCYY |
| . . . /Date/Month | String | 2 | Once | Required | Month: |
| | | | | | Format: MM |
| . . . /Date/Day | String | 2 | Once | Required | Day: |
| | | | | | Format: DD |
| . . . /Time | Aggregate | 0 | Once | Required | Time: |
| | | | | | Generated by ECN. |
| | | | | | Time of ErrorResponse creation. |
| . . . /Time/Hour | String | 2 | Once | Required | Hour: |
| | | | | | Format: HH |
| . . . /Time/Minute | String | 2 | Once | Required | Minute: |
| | | | | | Format: MM |
| . . . /Time/Second | String | 2 | Once | Required | Second: |
| | | | | | Format: SS |
| . . . /TimeZone | String | 3 | Once | Required | Time Zone: |
| | | | | | Generated by ECN. |
| | | | | | Time Zone for ErrorResponse |
| | | | | | creation timestamp. |
| . . . /SessionID | String | 12 | Once | Required | Session ID: |
| | | | | | Generated by ECN. |
| | | | | | ECN ID for the session in which |
| | | | | | the CustomerOffer document was |
| | | | | | transmitted to the ECN. May be |
| | | | | | used for audit trail purposes. |
| . . . /OffRcptCtrlID | String | 10 | Once | Required | Offer Receipt Control ID: |
| | | | | | Generated by ECN. |
| | | | | | ECN identifier used for tracking |
| | | | | | the Offer or CustomerOffer |
| | | | | | document. |
| . . . /SenderID | String | 8 | Once | Required | Sender ID: |
| | | | | | Generated by ECN. |
| | | | | | ECN user ID under which the |
| | | | | | Offer or CustomerOffer document |
| | | | | | was transmitted to the ECN. |
| . . . /DTDErrorList | Aggregate | 0 | Once | Required | DTD Error List: |
| | | | | | Generated by ECN. |
| | | | | | Encapsulates reporting of DTD |
| | | | | | violations. |
| . . . /DTDErrorList/ | String | 10 | Once | Required | DTD Error Count: |
| @DTDErrorCount | | | | | Count of . . . /DTDError[ ] elements |
| | | | | | to follow. |
| . . . /DTDErrorList/ | Aggregate | 0 | One | Required | DTD Error: |
| DTDError[ ] | List | | or | | Encapsulates the details of one |
| | | | Many | | DTD error. |
| . . . /DTDErrorList/ | String | 255 | Once | Required | Path Name: |
| DTDError[ ]/PathName | | | | | Path of DTD Error within the XML |
| | | | | | document. |
| . . . /DTDErrorList/ | String | 10 | Once | Required | Error Code: |
| DTDError[ ]/ErrorCode | | | | | Assigned according to the type |
| | | | | | and source of the Error Code. |
| . . . /DTDErrorList/ | String | 255 | Once | Required | Error Message: |
| DTDError[ ]/ErrorMessage | | | | | Text description of the DTD |
| | | | | | Error. |

In particular, the parameter SenderDocUID represents the unique code identifying the XML document to its sender. The ErrorCode parameter represents the code assigned by the network 13 for the type and source of the error. The ErrorDescription parameter represents a description of the error generated by the network 13. The ErrorCondition parameter is generated by the network 13 and represents the condition(s) that caused the generation of the error code. The ErrorMessage parameter identifies an error message generated by the network 13 based on the error code. The ErrorSource parameter represents the source of the error generated by the network 13. The Date and Time parameters identify the date and time, respectively, in which the ErrorResponse document is created. The SessionID parameter represents the identification value assigned by the network 13 for the session in which the Offer or CustomerOffer document was transmitted to the network 13. The OfrRptCtrlID parameter represents an identifier generated by the network 13 which is used for tracking the Offer or CustomerOffer document. The ServerID parameter represents the identification value generated by the network 13 under which the Offer or OfferCustomer document was transmitted to the network 13. The DTDErrorList element encapsulates the reporting of DTD violations, including the count of error containing elements to follow, the details of each DTD error, which comprises the path of the DTD error within the XML document, the error code, and the error message.

The details of the offers being distributed by each offer distributor 12 are electronically communicated to a network server 22 of system 10, such as an IBM RS6000 server, preferably in real time. Connections to server 22 are made over the Internet via the HTTP protocol using X.509 certificates to identify and authenticate the sender. Server 22 is configured to receive and authenticate all offers having a uniform format such as that previously described herein. With respect to offers distributed to customers in a non-interactive medium, the offer details are communicated to server 22 prior to being presented to the customers. In the case of a kiosk offer distributor, the offer is distributed via a communications network (not shown), such as the Internet, to a kiosk 16 in communication therewith. Kiosk 16 may be directly in communication with the POS system 27 of the store in which it is located.

System 10 generates point-of-sale (POS) maintenance files that reflect all of the offers received from the offer distributors 12 and authenticated by server 22. These files are stored within a database of network 13 (not shown), preferably in a consolidated manner whereby information related to all offers available from various offer distributors at a given retailer can be viewed online by customers via a browser interface 30 thereto. These files may be forwarded to the appropriate retailer 26 for placement on the POS systems 27 of the relevant stores 28 in which the offer is valid or a server of network 13 such as server 22 may place the files directly on the POS system 27 of the relevant stores 28 in which the offer is valid.

In one embodiment, network 13 provides for the possibility of cooperation between agents and partners in presenting offers to customers or in recording the customer's acceptance of an offer. Once a business relationship between the cooperating parties is established, the network 13 sets up the proper information pathways so that the XML documents created by the network 13 can be routed to agents or partners for the purpose of synchronizing information between the parties so that everyone has an exact copy of the information received by the network 13 from the offer distributors 12. The preferred formats of the relevant Offer Agent Server Routing, CustomerOffer Agent Server Routing, Agent Server Offer Acknowledgement and Agent Server Customer Offer Acknowledgement documents are described below.

Offer Agent Server Routing

| XML Element/Attribute | | Max | | | |
|---|---|---|---|---|---|
| Tag | Data Type | Len | Occur | Usage | Description |
| /SOX/TargetServerList | Aggregate | 0 | Once | Optional | Target Server List: |
| | | | | | This element is not required. |
| | | | | | Defines Agent servers to which |
| | | | | | this document is to be |
| | | | | | forwarded. |
| . . . /@ServerCount | String | 6 | Once | Required | Server Count: |
| | | | | | The number of |
| | | | | | . . . /TargetServerList/Server[ ] |
| | | | | | entries to follow. |
| | | | | | Value = 1-999999 |
| . . . /Server[ ] | Aggregate | 0 | One | Required | Server: |
| | List | | or | | Encapsulates details for one |
| | | | Many | | Agent server. |
| . . . /Server[ ]ServerID | String | 6 | Once | Required | Agent Server ID: |
| | | | | | Assigned by the ECN |
| | | | | | Target Agent Server ID to |
| | | | | | Receive a copy of this document. |
| | | | | | Value = 1-999999 |
| . . . /Server[ ]/ServicePriority | String | 2 | One | Required | Service Priority: |
| | | | | | Indicates maximum processing |
| | | | | | delay for requested routing |
| | | | | | service. |
| | | | | | Supported values: |
| | | | | | “15” = 15 Minutes |
| | | | | | “HR” = 1 Hour |
| | | | | | “ON” = Overnight |
| | | | | | “RT” = Real-time |

CustomerOffer Agent Server Routing

| XML Element/Attribute | | Max | | | |
|---|---|---|---|---|---|
| Tag | Data Type | Len | Occur | Usage | Description |
| /SOX/TargetServerList | Aggregate | 0 | Once | Optional | Target Server List: |
| | | | | | This element is not required. |
| | | | | | Defines Agent servers to which |
| | | | | | this document is to be |
| | | | | | forwarded. |
| . . . /@ServerCount | String | 6 | Once | Required | Server Count: |
| | | | | | The number of |
| | | | | | . . . /TargetServerList/Server[ ] |
| | | | | | entries to follow. |
| | | | | | Value = 1-999999 |
| . . . /Server[ ] | Aggregate | 0 | One | Required | Server: |
| | List | | or | | Encapsulates details for one |
| | | | Many | | Agent server. |
| . . . /Server[ ]/Server | String | 6 | Once | Required | Agent Server ID: |
| ID | | | | | Assigned by the ECN. |
| | | | | | Target Agent Server ID to |
| | | | | | receive a copy of this document. |
| | | | | | Value = 1-999999 |
| . . . /Server[ ]/ServicePriority | String | 2 | Once | Required | Service Priority: |
| | | | | | Indicates maximum processing |
| | | | | | delay for requested routing |
| | | | | | service. |
| | | | | | Supported values: |
| | | | | | “15” = 15 Minutes |
| | | | | | “HR” = 1 Hour |
| | | | | | “ON” = Overnight |
| | | | | | “RT” = Real-time |

### Agent Server Offer Acknowledgement

| XML Element/Attribute | | Max | | | |
|---|---|---|---|---|---|
| Tag | Data Type | Len | Occur | Usage | Description |
| /SOX/TargetServerList | Aggregate | 0 | Once | Optional | Target Server List: |
| | | | | | This element will exist if it |
| | | | | | was present in the Offer |
| | | | | | document, and encapsulates the |
| | | | | | results of Server Routing |
| | | | | | Request processing. |
| . . . /@ServerCount | String | 6 | Once | Required | Server Count: |
| | | | | | Count of |
| | | | | | . . . /TargetServerList/Server[ ] |
| | | | | | elements to follow. |
| | | | | | Value = 1-999999 |
| . . . /Server[ ] | Aggregate | 0 | One | Required | Server: |
| | List | | or | | Encapsulates details for one |
| | | | Many | | Agent server. |
| . . . /Server[ ]/Server | ID String | 6 | Once | Required | ServerID: |
| | | | | | Requested ServerID. |
| . . . /Server[ ]/ServicePriority | String | 2 | Once | Required | Service Priority: |
| | | | | | Requested service priority. |
| . . . /Server[ ]/Status | String | 9 | Once | Required | Status: |
| | | | | | Generated by ECN. |
| | | | | | Valid Values: |
| | | | | | Success |
| | | | | | Scheduled |
| . . . /Server[ ]/Result | Aggregate | 0 | Once | Required | Result: |
| | | | | | See result structure above. |

### Agent Server Customer Offer Acknowledgement

| XML Element/Attribute | | Max | | | |
|---|---|---|---|---|---|
| Tag | Data Type | Len | Occur | Usage | Description |
| /SOX/TargetServerList | Aggregate | 0 | Once | Optional | Target Server List: |
| | | | | | This element will exist if it |
| | | | | | was present in the CustomerOffer |
| | | | | | document, and encapsulates the |
| | | | | | results of Server Routing |
| | | | | | Request processing. |
| . . . /@ServerCount | String | 6 | Once | Required | Server Count: |
| | | | | | Count of |
| | | | | | . . . /TargetServerList/Server[ ] |
| | | | | | elements to follow. |
| | | | | | Value = 1-999999 |
| . . . /Server[ ] | Aggregate | 0 | One | Required | Server: |
| | List | | or | | Encapsulates details for one |
| | | | Many | | Agent server. |
| . . . /Server[ ]/ServerID | String | 6 | Once | Required | ServerID: |
| | | | | | Requested ServerID. |
| . . . /Server[ ]/ServicePriority | String | 2 | Once | Required | Service Priority: |
| | | | | | Requested service priority. |
| . . . /Server[ ]/Status | String | 9 | Once | Required | Status: |
| | | | | | Generated by ECN. |
| | | | | | Valid Values: |
| | | | | | Success |
| | | | | | Scheduled |
| . . . /Server[ ]/Result | Aggregate | 0 | Once | Required | Result: |
| | | | | | See result structure above. |

Customers redeem offers at a store electronically preferably via their loyalty cards or some other identification mechanism during the checkout process. The POS system 26 of that store integrates the offer details in the POS maintenance files received from server 22 into its POS master offer detail files so that the condition(s) associated with the offers can be validated. In a preferred embodiment, the validation is performed by FREEDOM-Shopper sold by Matra Systems. In one embodiment, this process is performed in batch mode given the processing-intensive nature of the operation that could adversely affect daily checkout operations.

POS system 26 generates transaction log files for any transactions at the stores 28 involving offers distributed by the offer distributors 12. These transaction log files are forwarded to system 10 for clearance and settlement. Clearing is the set of functions required to collect and analyze the transaction log files received by POS system 26 to extract the detail of the rewards given or due to customers, and to prepare the details of settlement required by the settlement agent. Clearing also includes extracting information from the transaction log files and comparing it against the corresponding offer details stored within the databases of network 13 in order to validate same. In one embodiment, clearance is performed via a program on the server 22 of the network 13. In a preferred embodiment, offer distributors 12 are notified of the redemption of their respective offers by means of a query service or XML-based data feed provided by server 22.

Once each offer is cleared, settlement of the offer with the appropriate settlement agent is performed. Settlement is the process of ensuring that the financial obligations associated with each offer are carried out. Specifically, the retailer is reimbursed for the value of rewards deducted from customer transactions involving offers. Payment must be arranged for fees due to the retailer and other parties for the processing and handling of the offer. Such settlement details are communicated electronically to a settlement agent 34 to complete settlement of the offer with the respective parties to the transaction.

Due to the centralized nature of the system 10 and the standardization of offers provided by the network 13, retailers can automatically accept offers from a plurality of different offer distributors, thereby relieving their burden to maintain sophisticated customer/price management systems. Moreover, system 10 allows paperless offer clearing at the POS level. In addition, system 10 provides for automatic settlement of offers which helps accelerate payment of the financial obligations associated therewith. In addition, given the centralized nature of the transaction information stored within the network 13, directories can be set up by network 13 whereby offer distributors, customers, stores, and other interested parties can easily look up information related to offers provided thorugh network 13.

Furthermore, network 13 provides for the dynamic targeting of customers. The value of customer targeting is derived from wasting less money on promotional activity. Promotions are inherently wasteful because a large amount of the expenditures are not used to alter customer behavior. Promotion costs can be classified primarily into three areas; namely media costs, redemption costs and handling and administrative costs. Media costs are the cost of exposing customers to a promotion offer. Media costs include the advertising cost for placing promotional ads in newspapers, magazines, or on the Internet offer, and direct mail cost to send offers to households. Redemption costs are the cost of the discount. Cash discounts and other rewards have direct costs. Handling and administrative costs are inherent with coupon offers, which generally have costs associated with having the coupons counted and for billing and administration. Additionally, coupon issuers provide a fee to the retailer to cover their costs in handling the coupon. Moreover, all promotions require systems to accrue, track and generally administer promotions.

The value of an offer is equal to the profit for incremental sales less the sum of media, redemption and handling and administrative costs associated therewith. Targeting offers can impact the value of an offer dramatically by lowering the overall costs and more particularly the cost per incremental case. Dynamic customer targeting is greatly enhanced by the system 10, specifically, due to the centralized nature in which the network 13 manages offer transactions. In particular, system 10 categorizes customer profiles into three types; namely static, persistent and dynamic. Static profiles represent lifestyle and geo-demographic characteristics and are not changed by marketing activities. Persistent profiles are characterized by buying behavior that is relatively stable and only somewhat altered by marketing activities. Dynamic profiles are characterized by buying behavior that can directly be attributed to marketing activities like discounts and new product introductions.

Referring now to FIG. 2, the process of dynamic customer targeting according to the present invention is described. For the purposes of discussion, it will be assumed that customers are identified to the network 13 through a loyalty card. However, it can be appreciated by one skilled in the art that any method of customer identification can be used. At 100, a customer is identified via a loyalty card being scanned at the checkout counter of a store. At 102, the POS system of that store tracks a plurality of information such as the customer's identification number, the time, the checkout lane, the products purchased, the prices paid and the quantities purchased. At 104, the POS system matches this information with information stored within the POS system, such as full pricing information, discount information, display activity, advertising activity and baseline sales, to create a customer profile. At 106, the profile is transmitted to the network 13 and at 108, the profile is appended to a “master” database stored within a database of the network 13. At 110, the customer profile is queried against this database to create the static, persistent and dynamic profiles at 112. At 114, the customer profiles are forwarded to the appropriate offer distributor 12 so they can dynamically target customers based on such profiles.

To illustrate the advantages of dynamic profiling, FIGS. 3A-D illustrate an example of an offer for spaghetti sauce distributed based on a non-targeted profile, a static profile, a persistent profile and a dynamic profile, respectively. As shown, the dynamic profile provides a net value of $24,000, while the non-targeted and static profiles provide no value, and the persistent profile provides only a $3,975 value. Therefore, for spaghetti sauce, it is unlikely that static profile will greatly distinguish large numbers of spaghetti sauce customers from non-spaghetti sauce customer. In other words, static profile type offers will not add to the value of the promotion.

The foregoing constitutes a description of various features of a preferred embodiment. Numerous changes to the preferred embodiment are possible without departing from the spirit and scope of the invention. Hence, the scope of the invention should be determined with reference not to the preferred embodiment, but to the following claims.

What is claimed is:

1. A method comprising:
maintaining a centralized server system that is coupled, via one or more network connections, to at least a plurality of different retailers;
maintaining, at the centralized server system, one or more databases of customer records describing customers, the customer records being associated with customer identifications;
receiving, at the centralized server system, from the plurality of different retailers, transaction logs comprising transaction details from particular transactions at point-of-sales operated by the plurality of retailers, wherein the transaction details include at least particular customer identifications, of the customer identifications, and information about specific products purchased in each transaction of the particular transactions;
receiving, at the centralized server system, from a plurality of different offer distributors, offer data describing a plurality of offers available for use in transactions at the point-of-sales operated by the plurality of retailers, the plurality of offers including dynamically targeted offers that are targeted to specific customers of the customers based on the transaction details and the customer records;
the centralized server system routing the offer data to the plurality of different retailers.

2. The method of claim 1, further comprising generating customer offer records for a particular offer of the dynamically targeted offers, each particular offer record of the customer offer records indicating whether the particular offer has been activated for a specific customer identification associated with the particular offer record.

3. The method of claim 1, wherein the transaction details further include information about offers redeemed in the particular transactions.

4. The method of claim 1, further comprising associating the customer records with profiles and selecting particular customers to distribute a specific offer to based on the profiles.

5. The method of claim 1, wherein the transaction details further include information about offers redeemed in the particular transactions, and wherein the method further comprises:
identifying particular customers whose buying behavior is highly correlated to marketing activities; and
targeting a particular offer to the particular customers.

6. The method of claim 1, wherein the plurality of different offer distributors include one or more of: a manufacturer, an Internet offer distributor, or a retailer.

7. The method of claim 1, wherein the customer identifications include different loyalty cards for different retailers.

8. The method of claim 1, further comprising providing transaction information, based on the received transaction logs, to one or more offer distributors of the plurality of offer distributors.

9. The method of claim 1, wherein the transaction details further include information about offers redeemed in the particular transactions, and wherein the method further comprises:
providing the plurality of offer distributors with a service for looking up transactional information related to particular offers of the plurality of offers.

10. The method of claim 1, further comprising receiving at least a portion of the customer records from the plurality of different retailers.

11. The method of claim 1, wherein the customer records are associated with profiles, further comprising sending information about the profiles to the plurality of offer distributors so that the plurality of offer distributors can dynamically target customers based on the profiles.

12. The method of claim 1, further comprising the centralized server system consolidating multiple offers of the dynamically targeted offers for presentation to the specific customers via browser interfaces.

13. The method of claim 1, further comprising the centralized server system consolidating multiple offers of the plurality of offers for presentation to the customers at a plurality of distribution levels, including an offer distributor level and a retailer level.

14. One or more non-transitory computer-readable media storing instructions which, when executed by one or more computing devices, cause:
maintaining a centralized server system that is coupled, via one or more network connections, to at least a plurality of different retailers;
maintaining, at the centralized server system, one or more databases of customer records describing customers, the customer records being associated with customer identifications;
receiving, at the centralized server system, from the plurality of different retailers, transaction logs comprising transaction details from particular transactions at point-of-sales operated by the plurality of retailers, wherein the transaction details include at least particular customer identifications, of the customer identifications, and information about specific products purchased in each transaction of the particular transactions;
receiving, at the centralized server system, from a plurality of different offer distributors, offer data describing a plurality of offers available for use in transactions at the point-of-sales operated by the plurality of retailers, the plurality of offers including dynamically targeted offers that are targeted to specific customers of the customers based on the transaction details and the customer records;
the centralized server system routing the offer data to the plurality of different retailers.

15. The one or more non-transitory computer-readable media of claim 14, wherein the instructions, when executed by the one or more computing devices, further cause generating customer offer records for a particular offer of the dynamically targeted offers, each particular offer record of the customer offer records indicating whether the particular offer has been activated for a specific customer identification associated with the particular offer record.

16. The one or more non-transitory computer-readable media of claim 14, wherein the transaction details further include information about offers redeemed in the particular transactions.

17. The one or more non-transitory computer-readable media of claim 14, wherein the instructions, when executed by the one or more computing devices, further cause associating the customer records with profiles and selecting particular customers to distribute a specific offer to based on the profiles.

18. The one or more non-transitory computer-readable media of claim 14, wherein the transaction details further include information about offers redeemed in the particular transactions, and wherein the method further comprises:
identifying particular customers whose buying behavior is highly correlated to marketing activities; and
targeting a particular offer to the particular customers.

19. The one or more non-transitory computer-readable media of claim 14, wherein the plurality of different offer distributors include one or more of: a manufacturer, an Internet offer distributor, or a retailer.

20. The one or more non-transitory computer-readable media of claim 14, wherein the customer identifications include different loyalty cards for different retailers.

21. The one or more non-transitory computer-readable media of claim 14, wherein the instructions, when executed by the one or more computing devices, further cause providing transaction information, based on the received transaction logs, to one or more offer distributors of the plurality of offer distributors.

22. The one or more non-transitory computer-readable media of claim 14, wherein the transaction details further include information about offers redeemed in the particular transactions, and wherein the method further comprises: providing the plurality of offer distributors with a service for looking up transactional information related to particular offers of the plurality of offers.

23. The one or more non-transitory computer-readable media of claim 14, wherein the instructions, when executed by the one or more computing devices, further cause receiving at least a portion of the customer records from the plurality of different retailers.

24. The one or more non-transitory computer-readable media of claim 14, wherein the customer records are associated with profiles, further comprising sending information about the profiles to the plurality of offer distributors so that the plurality of offer distributors can dynamically target customers based on the profiles.

25. The one or more non-transitory computer-readable media of claim 14, wherein the instructions, when executed by the one or more computing devices, further cause the centralized server system consolidating multiple offers of the dynamically targeted offers for presentation to the specific customers via browser interfaces.

26. The one or more non-transitory computer-readable media of claim 14, wherein the instructions, when executed by the one or more computing devices, further cause the centralized server system consolidating multiple offers of the plurality of offers for presentation to the customers at a plurality of distribution levels, including an offer distributor level and a retailer level.
